(19) United States
(12) Patent Application Publication
(10) Pub. No.: US 2019/0272943 A1
(43) Pub. Date: Sep. 5, 2019

(54) WIRELESS CHARGING COIL OF WIRELESS POWER TRANSMITTER AND RECEIVER, AND METHOD FOR PRODUCING SAME

(71) Applicant: LG INNOTEK CO., LTD., Seoul (KR)

(72) Inventor: Sung Hyun LEEM, Seoul (KR)

(73) Assignee: LG INNOTEK CO., LTD., Seoul (KR)

(21) Appl. No.: 16/345,574

(22) PCT Filed: Oct. 2, 2017
(86) PCT No.: PCT/KR2017/011098

§ 371 Date: Apr. 26, 2019

(30) Foreign Application Priority Data
Oct. 27, 2016 (KR) 10-2016-0140721

(51) Int. Cl. H01F 27/28; H01F 38/14; H02J 7/02; H02J 50/12; H01F 27/36; H01F 41/04; H02J 50/70

(52) U.S. Cl. CPC H01F 27/2885; H01F 38/14; H02J 7/025; H02J 50/70; H01F 27/365; H01F 41/04; H02J 50/12

(57) ABSTRACT

The present invention relates to a wireless power transmitter and receiver and a method for producing same. The wireless power transmitter according to an embodiment of the present invention may comprise: a plurality of coils for transmitting alternating current power; a plurality of resonance circuits corresponding to the plurality of coils; a drive circuit connected to the plurality of resonance circuits; a plurality of switches for connecting the plurality of resonance circuits with the drive circuit; and a shielding material integrated with one or more coils of the plurality of coils.

### TECHNICAL FIELD

The present invention relates to a wireless power transmitter and receiver, and a manufacturing method thereof.

### BACKGROUND ART

A mobile phone, a notebook computer, and similar portable terminals include a battery for storing electric power and a circuit for charging and discharging the battery. To charge a battery of such a terminal, electric power has to be received from an external charger.

In general, as an example of a type of electrical connection between a charging apparatus for charging the battery with electric power and the battery, there is a terminal supply type in which commercial power is received, converted to have voltage and current corresponding to the battery, and supplied as electric energy to the battery through terminals of the battery. Such a terminal supply type involves use of a physical cable or electric wire. Therefore, if many pieces of equipment of the terminal supply type are used, numerous cables occupy a considerable amount of workspace, are difficult to organize, and create a poor appearance. Further, the terminal supplying type may cause problems of instantaneous discharge due to different electric potential differences between the terminals, combustion and fire due to foreign materials, natural discharge, deterioration in the lifespan and performance of the battery, etc.

To solve these problems, there have recently been proposed a charging system and control methods thereof involving a method of wirelessly transmitting electric power (hereinafter referred to as a “wireless charging system”). Further, up through now, wireless charging systems have not been a basic part of some portable terminals, and a consumer has had to separately purchase wireless charging receiver accessories, thereby resulting in lower demands for wireless charging systems. However, it is expected that wireless charging users will rapidly increase and a terminal manufacturer will provide wireless charging as a basic feature in the future.

In general, the wireless charging system includes a wireless power transmitter transfer for supplying electric energy in a wireless power transmission manner, and a wireless power receiver for receiving the electric energy from the wireless power transmitter and charging the battery.

Such a wireless charging system may employ at least one wireless power transmission manner (for example, an electromagnetic induction manner, an electromagnetic resonance manner, radio frequency (RF) wireless power transmission manner, etc.) to transmit the electric power.

As an example, the wireless power transmission manner may use various wireless power transmission standards based on the electromagnetic induction manner employing the principle of electromagnetic induction, in which an electromagnetic field is generated in an electric power transmitter coil and electricity is induced in a receiver coil by the electromagnetic field. Herein, the wireless power transmission standards of the electromagnetic induction manner may include a wireless charging technology of the electromagnetic induction manner defined in the Wireless Power Consortium (WPC) or/and Power Matters Alliance (PMA).

As another example, the wireless power transmission manner may use the electromagnetic resonance manner, in which an electromagnetic field generated by a transfer coil of the wireless power transmitter resonates with a certain resonance frequency so that electric power can be transmitted to a wireless power receiver located nearby. Herein, the electromagnetic resonance manner may include the wireless charging technology of the resonance manner defined in the Airfuel (formerly A4wp) standard organization, i.e. wireless charging technology standard organization.

As still another example, the wireless power transmission manner may use the RF wireless power transmission manner, in which energy of low electric power is embedded in an RF signal to transmit the electric power to a wireless power receiver located at a distance.

Meanwhile, a wireless power transmitter or a wireless power receiver may include a plurality of coils. A wireless power transmitter or a wireless power receiver may extend a charging region by using a plurality of coils than when including a single coil. In addition, it is possible to dispose a shielding material in order to eliminate high frequency noise generated from a plurality of coils and to satisfy an electromagnetic wave (EMI) standard.

However, depending on an arrangement of coils, an overlapping region may be generated between the coils. In addition, inductance of each coil may change depending on a distance separated from a shielding material which affects the magnetic field generated by the coil. Further, another configuration for fixing a plurality of coils is required, and even if the plurality of coils are fixed in another configuration, they may be separated from the fixed position by an external impact.

### Technical Problem

The present invention is directed to providing a wireless charging coil of a wireless power transmitter and receiver, and a manufacturing method thereof.

In addition, the present invention is directed to providing a wireless charging coil of a wireless power transmitter and receiver in which a plurality of coils are fixed, and a manufacturing method thereof.

In addition, the present invention is directed to providing a wireless charging coil of a wireless power transmitter and receiver in which a plurality of coils are protected from an external impact, and a manufacturing method thereof.

In addition, the present invention is directed to providing a wireless charging coil of a wireless power transmitter and receiver in which a plurality of coils have heat resistance characteristics, and a manufacturing method thereof.

In addition, the present invention is directed to providing a wireless charging coil of a wireless power transmitter and receiver including a plurality of coils of which manufacturing costs are reduced, and a manufacturing method thereof.

In addition, the present invention is directed to providing a shielding material-integrated type wireless charging coil of a wireless power transmitter and receiver in which adhesion is enhanced when mounting a shielding material on a wiring board or the like, and a manufacturing method thereof.

In addition, the present invention is directed to providing a shielding material-integrated type wireless charging coil of a wireless power transmitter and receiver in which strength of a shielding material is enhanced, and a manufacturing method thereof.

Technical problems to be solved in the present invention are not limited to the above mentioned technical problems, and other technical problems not mentioned will be clearly understood by a person having ordinary skill in the art, to which the present invention pertains, from the following descriptions.

### Technical Solution

A shielding material-integrated type wireless charging coil according to an embodiment includes: a plurality of coils for transmitting or receiving wireless power; and a shielding material integrated with at least one of the plurality of coils.

In a shielding material-integrated type wireless charging coil according to another embodiment, a plurality of coils may include a first coil to a third coil, and the first coil and the second coil may be integrated with the shielding material.

In a shielding material-integrated type wireless charging coil according to still another embodiment, the shielding material may be disposed in contact with inside and outside of the first coil, and may be disposed in contact with inside and outside of the second coil.

In a shielding material-integrated type wireless charging coil according to still another embodiment, a burr cutting portion may be disposed on an upper surface of the shielding material.

In a shielding material-integrated type wireless charging coil according to still another embodiment, a burr cutting portion may be disposed on an outer wall portion of the shielding material.

In a shielding material-integrated type wireless charging coil according to still another embodiment, the burr cutting portion may be disposed toward the normal direction on an extension line of a normal line at one point of a cross section of the plurality of coils.

In a shielding material integrated type wireless charging coil according to still another embodiment, the shielding material may be disposed in contact with inside and outside of the first coil, in contact with inside and outside of the second coil, and in contact with inside of the third coil.

In a shielding material integrated type wireless charging coil according to still another embodiment, a burr cutting portion may be disposed on an upper surface of the shielding material.

In a shielding material integrated type wireless charging coil according to still another embodiment, the burr cutting portion may be disposed on an outer wall portion of the shielding material.

In a shielding material integrated type wireless charging coil according to still another embodiment, the burr cutting portion may be disposed toward the normal direction on an extension line of a normal line at one point of a cross section of the plurality of coils.

In a shielding material integrated type wireless charging coil according to another embodiment, a plurality of transmission coils may include a first coil to a third coil, and the first coil to the third coil may be integrated with the shielding material.

In a shielding material integrated type wireless charging coil according to still another embodiment, the shielding material may be disposed in contact with inside and outside of the first coil, in contact with inside and outside of the second coil, and in contact with inside and outside of the third coil.

In a shielding material integrated type wireless charging coil according to still another embodiment, a burr cutting portion may be disposed on an upper surface of the shielding material.

In a shielding material integrated type wireless charging coil according to still another embodiment, a burr cutting portion may be disposed on an outer wall portion of the shielding material.

In a shielding material integrated type wireless charging coil according to still another embodiment, the burr cutting portion may be disposed toward the normal direction on an extension line of a normal line at one point of a cross section of the plurality of coils.

As another solution of the above-described problem, in a method of manufacturing a shielding material-integrated type wireless charging coil including a first coil to a third coil for transmitting or receiving wireless power and a shielding material, it is possible to provide a method of manufacturing a shielding material-integrated type wireless charging coil including: disposing the first coil and the second coil on a bottom surface of a lower mold; forming a cavity including at least one gate by disposing an upper mold on the lower mold; filling the cavity with a liquid-state shielding material into the at least one gate; curing the liquid-state shielding material; and removing the lower mold and the upper mold.

A method of manufacturing a shielding material-integrated type wireless charging coil according to still another embodiment may further include removing an embossed burr formed in correspondence with the gate after removing the lower mold and the upper mold.

A method of manufacturing a shielding material-integrated type wireless charging coil according to still another embodiment may further include disposing the third coil to be overlapped on upper surfaces of the shielding material, the first coil, and the second coil after removing the lower mold and the upper mold.

In a method of manufacturing a shielding material-integrated type wireless charging coil according to still another embodiment, the lower mold may include a groove on the bottom surface.

In a method of manufacturing a shielding material-integrated type wireless charging coil according to still another embodiment, the groove may be disposed between an outside of the first coil and an outside of the second coil.

A method of manufacturing a shielding material-integrated type wireless charging coil according to still another embodiment may further include disposing the third coil to be overlapped on upper surfaces of the first coil and the second coil after removing the lower mold and the upper mold.

In a method of manufacturing a shielding material-integrated type wireless charging coil according to still another embodiment, the gate may be located on an upper surface or a lower surface of the lower mold or the upper mold.

In a method of manufacturing a shielding material-integrated type wireless charging coil according to still another embodiment, an embossed burr formed in accordance with the gate may be cut to form a burr cutting portion on an upper surface or a lower surface of the shielding material.

In a method of manufacturing a shielding material-integrated type wireless charging coil according to still another embodiment, the gate may be located on an outer wall portion of the lower mold or the upper mold.

In a method of manufacturing a shielding material-integrated type wireless charging coil according to still another embodiment, an embossed burr formed in accordance with the gate may be cut to form a burr cutting portion on an outer wall portion of the shielding material.

In a method of manufacturing a shielding material-integrated type wireless charging coil according to still another embodiment, the gate may be formed toward the normal direction on an extension line of a normal line at one point of a cross section of the first coil to the third coil.

In a method of manufacturing a shielding material-integrated type wireless charging coil according to still another embodiment, an embossed burr formed in accordance with the gate may be cut to form a burr cutting portion toward the normal direction on an extension line of a normal line at one point of a cross section of the first coil to the third coil.

As another solution of the above-described problem, it is possible to provide a wireless power transmitter including: a plurality of coils for transmitting AC power; a plurality of resonance circuits corresponding to the plurality of coils; one drive circuit connected to the plurality of resonance circuits; a plurality of switches connecting the plurality of resonance coils and the one drive circuit; and a shielding material integrated with at least one of the plurality of coils.

In a wireless power transmitter according to still another embodiment, a plurality of coils may include a first coil to a third coil, and the first coil and the second coil may be integrated with the shielding material.

In a wireless power transmitter according to still another embodiment, the shielding material may be disposed inside and outside the first coil, and may be disposed inside and outside the second coil.

In a wireless power transmitter according to still another embodiment, the shielding material may be disposed to extend at a first distance from a longitudinal outside of the first coil, and extend at a second distance from a lateral outside of the first coil.

In a wireless power transmitter according to still another embodiment, the third coil may be disposed to be overlapped on upper surfaces of the shielding material, the first coil, and the second coil.

In a wireless power transmitter according to still another embodiment, the first coil and the second coil may be disposed in the same direction, and the third coil may be disposed in the 90-degree direction of the first coil.

In a wireless power transmitter according to still another embodiment, the shielding material may be disposed inside and outside of the first coil, inside and outside of the second coil, and inside of the third coil.

In a wireless power transmitter according to still another embodiment, the shielding material may be disposed to extend at a first distance from a longitudinal outside of the first coil, and extend at a second distance from a lateral outside of the first coil.

In a wireless power transmitter according to still another embodiment, the third coil may be disposed to be overlapped on the upper surface of the first coil and the second coil.

In a wireless power transmitter according to still another embodiment, the first coil and the second coil may be disposed in the same direction.

In a wireless power transmitter according to still another embodiment, a plurality of transmission coils may include a first coil to a third coil, and the first coil to the third coil may be integrated with the shielding material.

In a wireless power transmitter according to still another embodiment, the shielding material may be disposed inside and outside of the first coil, inside and outside of the second coil, and inside and outside of the third coil.

In a wireless power transmitter according to still another embodiment, the shielding material may be disposed to extend at a first distance from a longitudinal outside of the first coil, and extend at a second distance from a lateral outside of the first coil.

In a wireless power transmitter according to still another embodiment, the third coil may be disposed to be overlapped on the upper surface of the shielding material, the first coil, and the second coil.

In a wireless power transmitter according to still another embodiment, the first coil and the second coil may be disposed in the same direction.

As another solution of the above-described problem, it is possible to provide a wireless power receiver including: a plurality of coils for receiving AC power; a control circuit for controlling the plurality of coils to receive the AC power; and a shielding material integrated with at least one of the plurality of coils.

In a wireless power receiver according to still another embodiment, a plurality of coils may include a first coil to a third coil, and the first coil and the second coil may be integrated with the shielding material.

In a wireless power receiver according to still another embodiment, the shielding material may be disposed inside and outside of the first coil, and may be disposed inside and outside of the second coil.

In a wireless power receiver according to still another embodiment, the shielding material may be disposed to extend at a first distance from a longitudinal outside of the first coil, and extend at a second distance from a lateral outside of the first coil.

In a wireless power receiver according to still another embodiment, the third coil may be disposed to be overlapped on the upper surface of the shielding material, the first coil, and the second coil.

In a wireless power receiver according to still another embodiment, the first coil and the second coil may be disposed in the same direction, and the third coil may be disposed in a 90-degree direction of the first coil.

In a wireless power receiver according to still another embodiment, the shielding material may be disposed inside and outside of the first coil, inside and outside of the second coil, and inside of the third coil.

In a wireless power receiver according to still another embodiment, the shielding material may be disposed to extend at a first distance from a longitudinal outside of the first coil, and extend at a second distance from a lateral outside of the first coil.

In a wireless power receiver according to still another embodiment, the third coil may be disposed to be overlapped on the upper surface of the first coil and the second coil.

In a wireless power receiver according to still another embodiment, the first coil and the second coil may be disposed in the same direction.

In a wireless power receiver according to still another embodiment, a plurality of transmission coils may include a first coil to a third coil, and the first coil to the third coil may be integrated with the shielding material.

In a wireless power receiver according to still another embodiment, the shielding material may be disposed inside and outside of the first coil, inside and outside of the second coil, and inside and outside of the third coil.

In a wireless power receiver according to still another embodiment, the shielding material may be disposed to extend at a first distance from a longitudinal outside of the first coil, and extend at a second distance from a lateral outside of the first coil.

In a wireless power receiver according to still another embodiment, the third coil may be disposed to be overlapped on the upper surface of the shielding material, the first coil, and the second coil.

In a wireless power receiver according to still another embodiment, the first coil and the second coil may be disposed in the same direction.

As another solution of the above-described problem, in a method of manufacturing a wireless power transmitter including a first coil to a third coil and a shielding material for transmitting wireless power, it is possible to provide a method of manufacturing a wireless power transmitter includes: disposing the first coil and the second coil on a bottom surface of a lower mold; forming a cavity including at least one gate by disposing an upper mold on the lower mold; filling the cavity with a liquid-state shielding material into the at least one gate; curing the liquid-state shielding material; and removing the lower mold and the upper mold.

A method of manufacturing a wireless power transmitter according to still another embodiment may further include removing an embossed burr formed in correspondence with the gate after removing the lower mold and the upper mold.

A method of manufacturing a wireless power transmitter according to still another embodiment may further include disposing to be overlapped the third coil on the upper surface of the shielding material, the first coil, and the second coil after removing the lower mold and the upper mold.

In a method of manufacturing a wireless power transmitter according to still another embodiment, the lower mold may include a groove on the bottom surface.

In a method of manufacturing a wireless power transmitter according to still another embodiment, the groove may be disposed between outside of the first coil and outside of the second coil.

A method of manufacturing a wireless power transmitter according to still another embodiment may further include disposing to be overlapped the third coil on the upper surface of the first coil and the second coil after removing the lower mold and the upper mold.

In a method of manufacturing a wireless power transmitter according to still another embodiment, a diameter of the groove is a size of sum of an inner length of the first coil, an inner length of the second coil, and an outer length of the third coil, and in disposing of the first coil and the second coil on the bottom surface of the lower mold, the third coil may be disposed in the groove, the first coil may be disposed to be overlapped on the bottom surface and the third coil, and the second coil may be disposed to be overlapped on the bottom surface and the third coil.

As another solution of the above-described problem, in a method of manufacturing a wireless power receiver including a first coil to a third coil and a shielding material for receiving wireless power, it is possible to provide a method of manufacturing a wireless power receiver includes: disposing the first coil and the second coil on a bottom surface of a lower mold; forming a cavity including at least one gate by disposing an upper mold on the lower mold; filling the cavity with a liquid-state shielding material into the at least one gate; curing the liquid-state shielding material; and removing the lower mold and the upper mold.

A method of manufacturing a wireless power receiver according to still another embodiment may further include removing an embossed burr formed in correspondence with the gate after removing the lower mold and the upper mold.

A method of manufacturing a wireless power receiver according to still another embodiment may further include disposing to be overlapped the third coil on the upper surface of the shielding material, the first coil, and the second coil after removing the lower mold and the upper mold.

In a method of manufacturing a wireless power receiver according to still another embodiment, the lower mold may include a groove on the bottom surface.

In a method of manufacturing a wireless power receiver according to still another embodiment, the groove may be disposed between outside of the first coil and outside of the second coil.

A method of manufacturing a wireless power receiver according to still another embodiment may further include disposing to be overlapped the third coil on the upper surface of the first coil and the second coil after removing the lower mold and the upper mold.

In a method of manufacturing a wireless power receiver according to still another embodiment, a diameter of the groove is a size of sum of an inner length of the first coil, an inner length of the second coil, and an outer length of the third coil, and in disposing of the first coil and the second coil on the bottom surface of the lower mold, the third coil may be disposed in the groove, the first coil may be disposed to be overlapped on the bottom surface and the third coil, and the second coil may be disposed to be overlapped on the bottom surface and the third coil.

### Advantageous Effects

Effects of a wireless charging coil of a wireless power transmitter and receiver and a manufacturing method thereof according to the present invention will be described as follows.

First, according to the present invention, a plurality of coils may be fixed without a separate configuration by integration with a shielding material.

Second, according to the present invention, a plurality of coils may be protected from external impact by an integrated shielding material.

Third, according to the present invention, a plurality of coils may have heat resistance characteristic by an integrated shielding material.

Fourth, according to the present invention, since a separate configuration is not required for fixing a plurality of coils, a manufacturing cost may be reduced.

Fifth, according to the present invention, since it is possible to have a wider charging region by using a plurality of transmission coils, thereby improving user convenience.

Sixth, according to the present invention, since only one of a plurality of identical circuits may be used, a size of the wireless power transmitter itself may be reduced, and parts used are reduced, thereby reducing the cost.

Seventh, according to the present invention, it is possible to use component elements defined in a published wireless power transmission standard, thereby following the already defined standard.

Eighth, according to the present invention, it is possible to improve the adhesion when a shielding material is mounted on a wiring board or the like.

Ninth, according to the present invention, it is possible to provide a shielding material with increased strength.

The effects expected in this embodiment are not limited to the foregoing effects, and other effects not mentioned above will be also easily understood from the above detailed descriptions by a person having an ordinary skill in the art to which the present embodiments pertain.

### DESCRIPTION OF DRAWINGS

The accompanying drawings are to help understanding of the present invention, and provide embodiments of the present invention in conjunction with the detailed description. However, the technical features of the present invention are not limited to specific drawings, and features disclosed in the drawings may combine with each other to form a new embodiment.

FIG. 1 is a block diagram for describing a wireless charging system according to one embodiment.

FIG. 2. is a block diagram for describing a wireless charging system according to another embodiment.

FIG. 3 is a view for describing a sensing signal transfer process in a wireless charging system according to an embodiment.

FIG. 4 is a view of a state transition for describing a wireless power transmission process defined in the WPC standards.

FIG. 5 is a view of a state transition for describing a wireless power transmission process defined in the PMA standards.

FIG. 6 is a block diagram for describing a structure of a wireless power transmitter according to one embodiment.

FIG. 7 is a block diagram for describing a structure of a wireless power receiver interworking with the wireless power transmitter of FIG. 6.

FIG. 8 is a view for describing a packet format in a wireless power transmission process of an electromagnetic induction manner according to one embodiment.

FIG. 9 is a view for describing the kind of packet transmittable in a ping phase by a wireless power receiving apparatus in the wireless power transmission process of an electromagnetic induction manner according to one embodiment.

FIG. 10 is a view for describing a message format of an identification packet in the wireless power transmission process of an electromagnetic induction manner according to one embodiment.

FIG. 11 is a view for describing message formats of a power control hold-off packet and a configuration packet in the wireless power transmission process of an electromagnetic induction manner according to one embodiment.

FIG. 12 is a view for describing the kind of packets transmittable in the power transmission phase by the wireless power receiving apparatus and their message formats in the wireless power transmission process of an electromagnetic induction according to one embodiment.

FIG. 13 is a view for describing arrangement of a plurality of coils and configuration of a shielding material according to one embodiment.

FIG. 14 is a view for describing a configuration in which one or more coils and a shielding material are integrated according to another embodiment.

FIG. 15 is a view for describing a method of manufacturing integrated one or more coils and a shielding material in another embodiment according to FIG. 14.

FIG. 16 is a view for describing a configuration in which one or more coils and a shielding material are integrated according to still another embodiment.

FIG. 17 is a view for describing a method of manufacturing integrated one or more coils and a shielding material in another embodiment according to FIG. 16.

FIG. 18 is a view for describing a configuration in which a plurality of coils and a shielding material are integrated according to yet another embodiment.

FIG. 19 is view for describing a method of manufacturing a plurality of coils and a shielding material integrated in another embodiment according to FIG. 18.

FIG. 20 is a view for describing a shielding material-integrated type wireless charging coil and a manufacturing method thereof according to one embodiment.

FIG. 21 is a view for describing a shielding material-integrated type wireless charging coil and a manufacturing method thereof according to another embodiment.

FIG. 22 is a view for describing a shielding material-integrated type wireless charging coil and a manufacturing method thereof according to still another embodiment.

FIG. 23 is a view for describing a shielding material-integrated type wireless charging coil and a manufacturing method thereof according to yet another embodiment.

FIG. 24 is a view for describing three drive circuits including a full-bridge invertor in a wireless power transmitter including a plurality of coils according to one embodiment.

FIG. 25 is a view for describing a wireless power transmitter including a plurality of coils and one drive circuit according to one embodiment.

FIG. 26 is a view for describing a drive circuit including a full-bridge invertor according to one embodiment.

FIG. 27 is a view for describing a plurality of switches for connecting any one of a plurality of transmission coils to a drive circuit according to one embodiment.

### MODES OF THE INVENTION

Hereinafter, apparatus and various methods according to embodiments will be described in detail with reference to the accompanying drawings. Suffixes “module” and “part” for elements used in the following descriptions are given or used just for convenience in writing the specification, and do not have meanings or roles distinguishable between them.

Although all elements described in above embodiments are combined into one or operate as they are combined, the present disclosure is not limited to the embodiments. In other words, one or more elements among all of them may be selectively combined and operate without departing from the scope of the present disclosure. Further, all the elements may be respectively materialized as single independent hardware components, but some or all of them may be selectively combined and materialized as a computer program having a program module to perform some or all functions combined in a single or plural hardware components. Codes and code segments of the computer program may be easily conceived by a person having an ordinary skill in the art. Such a computer program may be stored in computer readable media, and read and executed by a computer, thereby materializing the embodiments. The medium for storing the computer program may include a magnetic recording medium, an optical recording medium, a carrier wave medium, etc.

In describing the embodiments, if elements are described with terms “above (up) or below (down)”, “front (head) or back (rear)”, the terms “above (up) or below (down)”, “front (head) or back (rear)” may refer to meanings of direct contact between two elements or one or more elements interposed between the two elements.

Further, it will be understood that the term “include”, “comprise” or “have”, etc. used as above means a presence of an element unless otherwise stated, and does not preclude the presence or addition of one or more other elements. Unless otherwise defined, all terms including technical and scientific terms used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined here.

Further, elements of the present disclosure may be described with terms first, second, A, B, (a), (b), etc. These terms are only used to distinguish one element from another, and do not limit the element's own meaning, sequence, order, etc. It will be understood that when an element is referred to as being “connected”, “combined” or “coupled” to another element, it can be directly connected or coupled to the other element or intervening elements may be “connected”, “combined” or “coupled” between the elements.

Further, in the present disclosure, detailed descriptions of the related well-known art may be omitted if the well-known art is obvious to those skilled in the art and may cloud the gist of the present disclosure.

In describing embodiments, an apparatus for wirelessly transmitting electric power in a wireless power charging system may be also called a wireless power transmitter, a wireless power transmission apparatus, a transmitting terminal, a transmitter, a transmitting apparatus, a transmitting side, a wireless power transmitting apparatus, a wireless power transmitter, a wireless charging apparatus, or the like for convenience of description. Further, an apparatus for wirelessly receiving electric power from the wireless power sending apparatus may be also called a wireless power receiving apparatus, a wireless power receiver, a receiving terminal, a receiving side, a receiving apparatus, a receiver terminal, or the like for convenience of description.

The wireless charging apparatus according to an embodiment may be provided as a pad type, a support type, an access point (AP) type, a small base station type, a stand type, a ceiling embedded type, a wall mount type, etc. and one transmitter may transmit electric power to a plurality of wireless power receiving apparatuses.

For example, the wireless power transmitter may be typically used when put on a desk or table and also used in a vehicle when developed for a vehicle. The wireless power transmitter installed in the vehicle may be provided as a support type to be conveniently and stably held and supported.

A terminal according to an embodiment may be used for a small electronic device such as a mobile phone, a smart phone, a notebook computer (or a laptop computer), a digital broadcasting terminal, a personal digital assistant (PDA), a portable multimedia player (PMP), a global positioning system (GPS), an MP3 player, an electric toothbrush, an electronic tag, an illumination system, a remote controller, a fishing float, or the like, but not limited thereto. Alternatively, the terminal may include any mobile device (hereinafter referred to as an “electronic device”) provided with a wireless power receiving means according to an embodiment and capable of battery charging, and the terms “terminal” and “device” may both be used. According to another embodiment, the wireless power receiver may be mounted to a vehicle, an unmanned aircraft, an air drone, etc.

According to an embodiment, the wireless power receiver may employ at least one wireless power transmission manner, and may simultaneously receive wireless power from two or more wireless power transmitters. Herein, the wireless power transmission manner may include at least one among an electromagnetic induction manner, an electromagnetic resonance manner, and an RF wireless power transmission manner. In particular, the wireless power receiving means supporting the electromagnetic induction manner may include the wireless charging technology of the electromagnetic induction manner defined in the AirFuel Alliance (formerly PMA) and Wireless Power Consortium (WPC), i.e. wireless charging technology standard organizations. Further, the wireless power receiving means supporting the electromagnetic resonance manner may include the wireless charging technology of the resonance manner defined in the Airfuel (formerly A4WP) standard organization, i.e. wireless charging technology standard organization.

In general, the wireless power transmitter and the wireless power receiver of the wireless power system may exchange a control signal or information through in-band communication or Bluetooth low energy (BLE) communication. Herein, in-band communication and BLE communication may be performed by a pulse width modulation (PWM) method, a frequency modulation (FM) method, a phase modulation (PM) method, an amplitude modulation (AM) method, an AM-PM method, etc. For example, the wireless power receiver generates a feedback signal by applying a predetermined on/off switching pattern to an electric current induced through a receiving coil and thus transmits various control signals and information to the wireless power transmitter. The information received from the wireless power receiver may include various pieces of information such as a level of received power. In this case, the wireless power transmitter may calculate a charging efficiency or a power transmission efficiency based on information about the level of the received power.

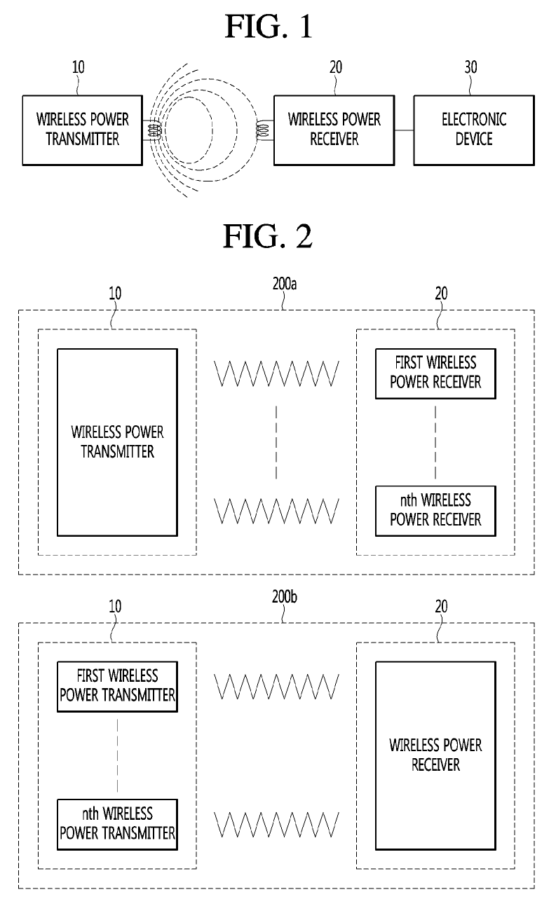

FIG. 1 is a block diagram for describing a wireless charging system according to one embodiment.

Referring to FIG. 1, the wireless charging system may generally include a wireless power transmitter 10 for wirelessly transmitting power, a wireless power receiver 20 for receiving the transmitted power, and an electronic device 30 to which the received power is supplied.

For example, the wireless power transmitter 10 and the wireless power receiver 20 may perform in-band communication to exchange information through the same frequency band as an operation frequency used in wirelessly transmitting power. Alternatively, the wireless power transmitter 10 and the wireless power receiver 20 may perform out-of-band communication to exchange information through a separate frequency band different from the operation frequency used in wirelessly transmitting the wireless power.

For example, the information exchanged between the wireless power transmitter 10 and the wireless power receiver 20 may include not only their state information but also control information. Herein, the state information and the control information exchanged in between the transmitting/receiving terminals will become apparent through descriptions of the following embodiments.

In-band communication and out-of-band communication may provide bidirectional communication, but is not limited thereto. According to another embodiment, in-band communication and out-of-band communication may provide unidirectional communication or half-duplex communication.

For example, unidirectional communication may mean that the wireless power receiver 20 transmits information only to the wireless power transmitter 10, but is not limited thereto. Alternatively, the wireless power transmitter 10 may transmit information to the wireless power receiver 20.

The half-duplex communication allows bidirectional communication between the wireless power receiver 20 and the wireless power transmitter 10, but allows only one of them to transmit information at a time.

According to one embodiment, the wireless power receiver 20 may obtain various pieces of state information of the electronic device 30. For example, the state information of the electronic device 30 may include information about an amount of currently used power, information for identifying running applications, information about usage of a central processing unit (CPU), information about a battery charging state, information about battery output voltage/current, etc., but is not limited thereto. Alternatively, the state information may include any information that can be obtained from the electronic device 30 and can be usable for wireless power control.

In particular, the wireless power transmitter 10 according to one embodiment may transmit a predetermined packet, which informs whether quick charging is supported or not, to the wireless power receiver 20. When it is determined that the connected wireless power transmitter 10 supports the quick charging mode, the wireless power receiver 20 may inform the electronic device 30 that the connected wireless power transmitter 10 supports the quick charging mode. The electronic device 30 may display that quick charging is possible through a provided predetermined display means, for example, a liquid crystal display.

In addition, a user of the electronic device 30 may select a predetermined quick charging request button displayed on the display means so as to control the wireless power transmitter 10 so that it operates in the quick charging mode. In this case, the electronic device 30 may transmit a predetermined quick charging request signal to the wireless power receiver 20 when a user selects the quick charging request button. The wireless power receiver 20 generates a charging mode packet corresponding to the received quick charging request signal and transmits it to the wireless power transmitter 10, thereby switching the normal low power charging mode to the quick charging mode.

FIG. 2 is a block diagram for describing a wireless charging system according to another embodiment.

For example, as shown by the reference numeral of ‘200a’, the wireless power receiver 20 may include a plurality of wireless power receivers, and one wireless power transmitter 10 may connect with the plurality of wireless power receivers to thereby perform wireless charging. In this case, the wireless power transmitter 10 may distribute and transmit the power to the plurality of wireless power receivers through time division control, but is not limited thereto. Alternatively, the wireless power transmitter 10 may distribute and transmit the power to the plurality of wireless power receivers through different frequency bands assigned according to the wireless power receivers.

In this case, the number of wireless power receivers connectable to one wireless power transmitter may be adaptively determined based on at least one among power required by the wireless power receivers, a battery charging state, a power consumption amount of the electronic device, and available power of the wireless power transmitter.

As another example, as shown in FIG. 200b, the wireless power transmitter 10 may include a plurality of wireless power transmitters. In this case, the wireless power receiver 20 may simultaneously connect with the plurality of wireless power transmitters and receive the power from the connected wireless power transmitters to thereby perform charging. In this case, the number of wireless power transmitters connected to the wireless power receiver 20 may be adaptively determined based on power required by the wireless power receiver 20, the power, the battery charging state, the power consumption amount of the electronic device, and available power of the wireless power transmitter, etc.

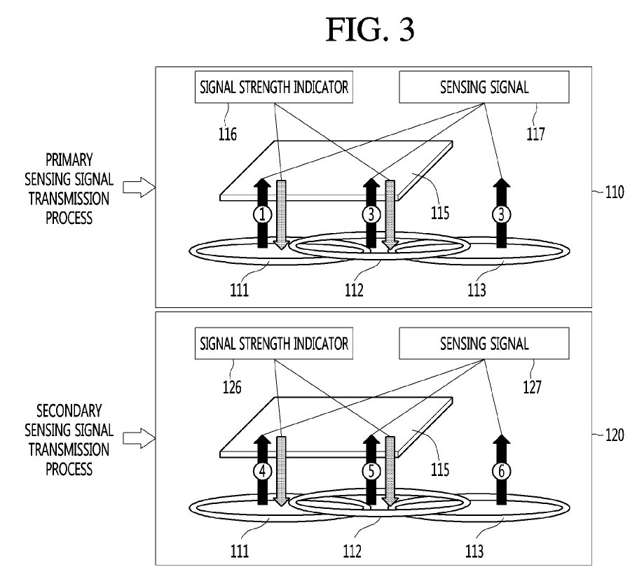

FIG. 3 is a view for describing a sensing signal transfer process in the wireless charging system according to one embodiment.

For example, the wireless power transmitter may be provided with three transfer coils 111, 112 and 113. The transfer coil may partially overlap with another transfer coil, and the wireless power transmitter may sequentially transmit predetermined sensing signals 117 and 127—for example, digital ping signals—in a predetermined order to sense the presence of the wireless power receiver through the transfer coils.

As shown in FIG. 3, the wireless power transmitter sequentially transmits the sensing signals 117 through a primary sensing signal transfer process denoted by the reference numeral of ‘110’ and identifies the transfer coils 111 and 112, in which a signal strength indicator (or a signal strength packet) 116 is received from a wireless power receiver 115. Then, the wireless power transmitter sequentially transmits the sensing signals 127 through a secondary sensing signal transfer process denoted by the reference numeral of ‘120’, identifies the transfer coil, which has a high power transmission efficiency (or charging efficiency)—i.e. is well aligned with the receiving coil—between the transfer coils 111 and 112 in which a signal strength indicator 126 is received, and controls the identified transfer coil to be used in transmitting the power—i.e. performing the wireless charging.

As shown in FIG. 3, the wireless power transmitter performs the sensing signal transfer process two times in order to more precisely identify which transfer coil is well aligned with the receiving coil of the wireless power receiver.

As shown in the reference numerals of 110 and 120 in FIG. 3, when the signal strength indicators 116 and 126 are received in the first transfer coil 111 and the second transfer coil 112, the wireless power transmitter selects the best aligned transfer coil based on the signal strength indicator 126 received in the first transfer coil 111 and the second transfer coil 112, and uses the selected transfer coil to perform the wireless charging.

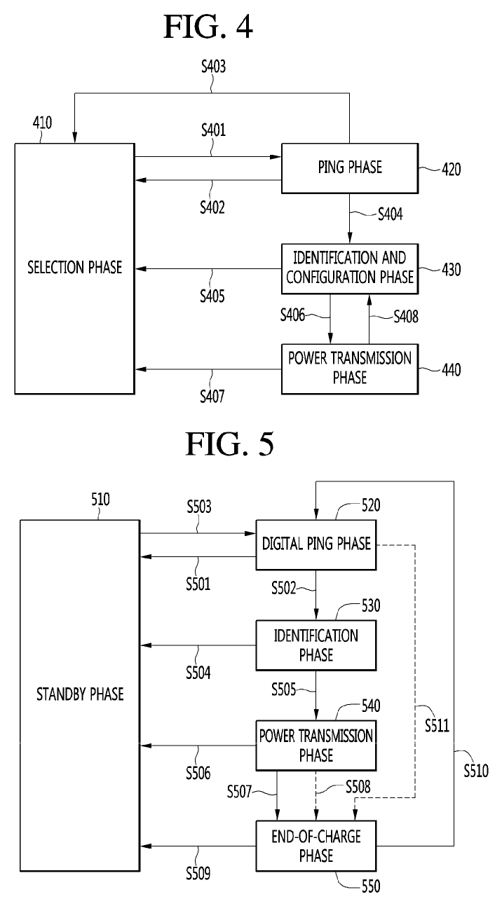

FIG. 4 is a state transition view for describing a wireless power transmission process defined in the WPC standards.

Referring to FIG. 4, according to the WPC standards, the power transmission from the transmitter to the receiver is generally divided into a selection phase 410, a ping phase 420, an identification and configuration phase 430, a power transfer phase 440.

The selection phase 410 may be a transition phase when a specific error or a specific event is sensed while power transmission is started or power transmission is maintained. Herein, the specific error or the specific event will become apparent through the following descriptions. Further, in the selection phase 410, the transmitter may monitor whether an object is present on an interface surface. When the transmitter senses that an object is put on the interface surface, transition to the ping phase 420 is possible. In the selection phase 410, the transmitter transmits an analog ping signal having a very short pulse and may sense whether an object is present in an active area of the interface surface based on change in a current of the transfer coil.

When an object is sensed in the ping phase 420, the transmitter wakes up the receiver and transmits a digital ping for identifying whether the receiver is a WPC compliant receiver. In the ping phase 420, when the transmitter receives no response signal as a response to the digital ping—for example, no signal strength indicator—from the receiver, transition to the selection phase 410 is possible (S402). Further, when the transmitter receives a signal—i.e. a charging completion signal—informing that the power transmission has been completed, transition from the ping phase 420 to the selection phase 410 may be possible (S403).

When the ping phase 420 is completed, the transmitter identifies the receiver and enters the identification and configuration phase 430 for collecting information about the configuration and state of the receiver (S404).

When an unexpected packet is received, an expected packet goes beyond a predetermined time limit (i.e. times out), there is a packet transfer error, or no power transmission contract is set in the identification and configuration phase 430, the transmitter may return to the selection phase 410 (S405).

When the identification and configuration for the receiver is completed, the transmitter may transition to power transfer phase 440, which transmits the wireless power (S406).

When an unexpected packet is received, an expected packet goes beyond a predetermined time limit (i.e. times out), preset power transmission contract is violated, or charging is completed, the transmitter in the power transfer phase 460 may return to the selection phase 410 (S407).

In addition, in the power transfer phase 440, when there is a need for reconfiguring the power transmission contract in accordance with changes in the state of the transmitter, the transmitter may enter the identification and configuration phase 430 (S408).

The power transmission contract may be set based on the state and characteristic information of the transmitter and the receiver. For example, the state information of the transmitter may include information about the maximum transmittable power, information about the maximum supportable number of the receivers, etc., and the state information of the receiver may include information about required power.

FIG. 5 is a view of a state transition for describing a wireless power transmission process defined in the PMA standards.

Referring to FIG. 5, the power transmission from the transmitter to the receiver according to the PMA standards may be generally divided into a standby phase 510, a digital ping phase 520, an identification phase 530, a power transmission phase 540, and an end-of-charge phase 550.

The standby phase 510 may be a transition phase to which returns are made when a specific error or a specific event is sensed while a process for identifying the receiver is performed for power transmission or while the power transmission is in progress. Herein, the specific error or the specific event will become apparent through the following descriptions. Further, in the standby phase 510, the transmitter may monitor whether an object is present on a charging surface. When it is sensed that an object is put on the charging surface or RXID is being restarted, the transmitter may enter the digital ping phase 520 (S501). Herein, the RXID refers to a unique identifier assigned to a PMA compatible the receiver. In the standby phase 510, the transmitter transmits an analog ping of very short pulses to sense whether an object is present on an active area of an interface surface—for example, a charging bed—based on current variation of the transfer coil.

In the digital ping phase 520, the transmitter transmits a digital ping signal for identifying whether the sensed object is a PMA compatible the receiver. When the receiver receives enough power from the digital ping signal transmitted from the transmitter, the receiver modulates the received digital ping signal in accordance with PMA communication protocols and transmits a predetermined response signal to the transmitter. Herein, the response signal may include a signal strength indicator for indicating the level of the power received in the receiver. When a valid response signal is received in the digital ping phase 520, the transmitter may enter the identification phase 530 (S502).

In the digital ping phase 520, when the response signal is not received or the sensed object is not the PMA compatible receiver, —i.e. in case of the FOD—, the transmitter may return to the standby phase 510 (S503). For example, a foreign object (FO) may be a metallic material such as a coin, a key, etc.

In the identification phase 530, when the transmitter fails the receiver identifying process or has to restart the receiver identifying process and does not complete the receiver identifying process within a preset time limit, the transmitter may return to the standby phase 510 (S504).

When the transmitter succeeds in identifying the receiver, the transmitter switches over from the identification phase 530 to the power transmission phase 540, thereby starting the charging (S505).

In the power transmission phase 540, when an expected signal goes beyond a predetermined time limit (i.e. times out) or when a voltage of the transfer coil exceeds a previously defined reference level, the transmitter may return to the standby phase 510 (S506).

In addition, in the power transmission phase 540, when a temperature sensed by a built-in temperature sensor exceeds a predetermined reference value, the transmitter may enter the end-of-charge phase 550 (S507).

In the end-of-charge phase 550, when it is determined that the receiver has been removed from the charging surface, the transmitter may return to the standby phase 510 (S509).

Further, the transmitter may switch over from the end-of-charge phase 550 to the digital ping phase 520 when the temperature sensed after a predetermined period of time is elapsed is equal to or lower than a reference value in case of excessive temperature (S510).

In the digital ping phase 520 or the power transmission phase 540, when the transmitter receives an end-of-charge (EOC) request from the receiver, the transmitter may enter the end-of-charge phase 550 (S508 and S511).

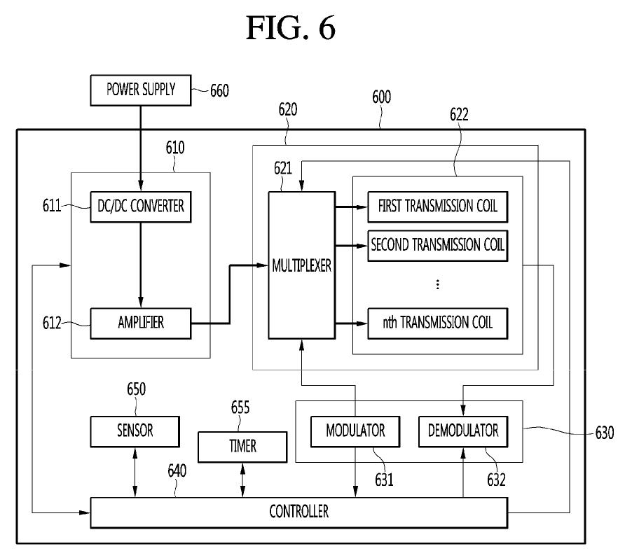

FIG. 6 is a block diagram for describing a structure of a wireless power transmitter according to one embodiment.

Referring to FIG. 6, a wireless power transmitter 600 may generally include a power converter 610, a power transmitter 620, a communicator 630, a controller 640, and a sensor 650. This structure of the wireless power transmitter 600 is not essential, and thus may include more or less elements than these elements.

As shown in FIG. 6, the power converter 610 may perform a function for converting power into power having a predetermined level when receiving the power from a power supply 660.

To this end, the power converter 610 may include a DC/DC converter 611 and an amplifier 612.

The DC/DC converter 611 may convert the DC power supplied from the power supply 660 into the DC power having a specific level in response to a control signal of the controller 640.

In this case, the sensor 650 may sense voltage, current, etc. of the DC power and inform the controller 640 of them. Further, the sensor 650 may sense an internal temperature of the wireless power transmitter 600 to determine whether overheating occurs and provide a sensing result to the controller 640. For example, the controller 640 may adaptively cut off the power supplied from the power supply 650 or prevent the power from being supplied to the amplifier 612 on the basis of the voltage/current sensed by the sensor 650. To this end, the power converter 610 may further include a predetermined power cut-off circuit at one side thereof to cut off the power supplied from the power supply 650 or the power supplied to the amplifier 612.

The amplifier 612 may adjust the level of the power obtained by the DC/DC conversion in accordance with the control signal of the controller 640.

For example, the controller 640 may receive information about a power receiving state of the wireless power receiver and/or a power control signal through the communicator 630, and dynamically adjust an amplification rate of the amplifier 612 based on the information about the power receiving state and/or the power control signal. For example, the power receiving state information may include information about an output voltage level of a rectifier, level information about a current applied to the receiving coil, etc. but is not limited thereto. The power control signal may include a signal requesting an increase of the power, a signal of requesting a decrease of the power, etc.

The power transmitter 620 may include a multiplexer 621 and a transfer coil 622. Further, the power transmitter 620 may further include a carrier wave generator (not shown) for generating a specific operation frequency to transmit the power.

The carrier wave generator may generate a specific frequency to convert the output DC power of the amplifier 612 received through the multiplexer 621 into AC power having the specific frequency. In this description, an AC signal generated by the carrier wave generator is mixed with an output terminal of the multiplexer 621 to thereby generate AC power, but this is merely an embodiment. Alternatively, the AC signal may be mixed at the anterior or posterior terminal of the amplifier 612.

The frequency of the AC power transmitted to each of the transmission coils according to one embodiment may be different from each other, and in another embodiment, the resonance frequency of each of the transmission coils may be set differently by using a predetermined frequency controller having a function of adjusting the LC resonance characteristic for each transmission coil differently.

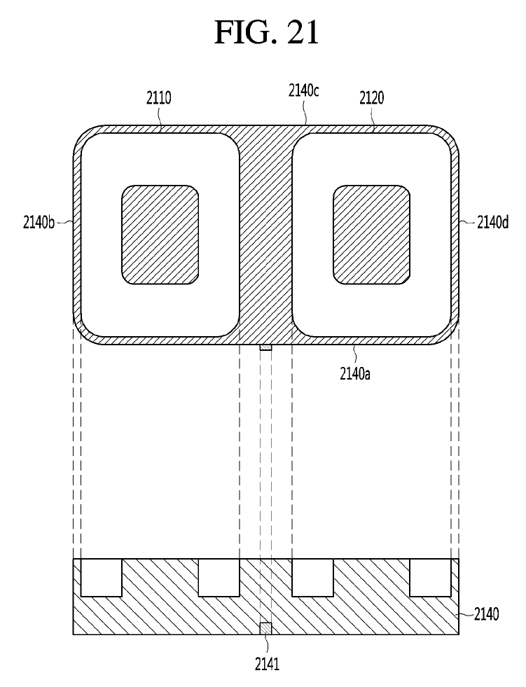

However, when the resonant frequencies generated in each of the plurality of transmission coils are different, a separate frequency controller for controlling the resonant frequencies is required, which may increase the size of the wireless power transmitter. Accordingly, in one embodiment, the case in which power is transmitted by using the same resonance frequency even though the wireless power transmitter includes a plurality of transmission coils will be described in FIGS. 21 to 23.

As shown in FIG. 6, the power transmitter 620 may include the multiplexer 621 and a plurality of transfer coils 622—i.e., first to nth transfer coils—to control the output power of the amplifier 612 to be transferred to the transfer coil.

According to one embodiment, when the plurality of wireless power receivers are connected, the controller 640 may transmit the power through time-division multiplexing according to the transfer coils. For example, when the wireless power transmitter 600 identifies three wireless power receivers—i.e., the first to third wireless power receivers—through three different transfer coils—i.e., the first to third transfer coils —, the controller 640 controls the multiplexer 621 so that the power can be transmitted through a specific transfer coil in a specific timeslot. In this case, the amount of power transmitted to the corresponding wireless power receiver may be controlled in accordance with lengths of timeslots assigned according to the transfer coils, but this is merely an embodiment. Alternatively, the amplification rate of the amplifier 612 may be controlled during the timeslot assigned to each transfer coil, thereby controlling the power transferred according to the wireless power receivers.

The controller 640 may control the multiplexer 621 so that the sensing signals can be sequentially transmitted through the first to nth transfer coils 622 during the primary sensing signal transfer process. In this case, the controller 640 may use a timer 655 to identify a point in time at which the sensing signals are transmitted, and control the multiplexer 621 when it reaches the point in time so that it transmits the sensing signals so that the sensing signal can be transmitted through the corresponding transfer coil. For example, the timer 650 may transmit a specific event signal to the controller 640 at a predetermined cycle during a ping transfer phase, and the controller 640 may control the multiplexer 621 so that a digital ping can be transmitted through the corresponding transfer coil when the corresponding event signal is sensed.

In addition, during the primary sensing signal transfer process, the controller 640 may receive a predetermined transfer coil identifier, which identifies whether the signal strength indicator has been received through a certain transfer coil, from a demodulator 632 and receive the signal strength indicator received through the corresponding transfer coil. Continuously, during the secondary sensing signal transfer process, the controller 640 may control the multiplexer 621 so that the sensing signals can be transmitted through only the transfer coil(s) in which the signal strength indicator is received during the primary sensing signal transfer process. Alternatively, when there are a plurality of transfer coils in which the signal strength indicator is received during the primary sensing signal transfer process, the controller 640 may determine the transfer coil, in which the signal strength indicator having the highest value is received, as the transfer coil for transmitting a sensing signal first during the secondary sensing signal transfer process, and control the multiplexer 621 in accordance with determination results.

A modulator 631 modulates the control signal generated by the controller 640 and transmits it to the multiplexer 621. Herein, a method of modulating the control signal may include a frequency shift keying (FSK) modulation method, a Manchester coding modulation method, a phase shift keying (PSK) modulation method, a pulse width modulation (PWM) method, a differential bi-phase modulation method, etc. without limitations.

When sensing a signal received through the transmission coil, the demodulator 632 demodulates the sensed signal and transmits it to the controller 640. Herein, the demodulated signal may include a signal strength indicator, an error correction (EC) indicator for controlling power during the wireless power transfer, an end-of-charge (EOC) indicator, an overvoltage/overcurrent/overheat indicator, etc. without limitations, and may include various pieces of status information for identifying the state of the wireless power receiver.

Further, the demodulator 32 may identify which transmission coil the demodulated signal is received from, and provide a predetermined transmission coil identifier corresponding to the identified transmission coil to the controller 640.

For example, the wireless power transmitter 600 may obtain the signal strength indicator through in-band communication that uses the same frequency used for wireless power transmission to communicate with the wireless power receiver.

Further, the wireless power transmitter 600 may use the transmission coil 622 to not only wirelessly transmission the power but also exchange various pieces of information with the wireless power receiver. Alternatively, the wireless power transmitter 600 may additionally include a separate coil corresponding to the transmission coils 622—i.e., the first to nth transmission coils, and use the separate coil to perform the In-band communication with the wireless power receiver.

In the foregoing description with FIG. 6, the wireless power transmitter 600 and the wireless power receiver perform the In-band communication, but this is merely an embodiment. Alternatively, they may perform a near field interactive communication through a frequency band different from the frequency band used in transmitting the wireless power signal. For example, the near field interactive communication may be one among low power Bluetooth communication, RFID communication, UWB communication, ZigBee communication, etc.

In particular, the wireless power transmitter 600 according to an embodiment of the present invention may adaptively provide a fast charging mode and a normal low power charging mode at the request of the wireless power receiver.

The wireless power transmitter 600 may transmit a signal of a predetermined pattern, which is called a first packet for convenience of explanation, when the fast charging mode is supported. The wireless power receiver 600 may identify that the wireless power transmitter 600 being connected is capable of fast charging when the first packet is received.

In particular, the wireless power receiver may send a predetermined first response packet to the wireless power transmitter 600 requesting fast charging if fast charging is required.

In particular, the wireless power transmitter 600 may automatically switch to the fast charging mode and initiate fast charging when a predetermined time elapses after the first response packet is received.

For example, when the control unit 640 of the wireless power transmitter 600 transits to the power transmission phase 440 or 540 of FIGS. 4 and 5, the control unit 640 may control the first packet to be transmitted through the transmission coil 622. However, this is only one embodiment, and in another example of the present invention, the first packet may be sent out in the identification and configuration phase 430 of FIG. 4 or the identification step 530 of FIG. 5.

It should be noted in still another embodiment that information that may identify whether or not a fast charging support is available to the digital ping signal transmitted by the wireless power transmitter 600 may be encoded and transmitted.

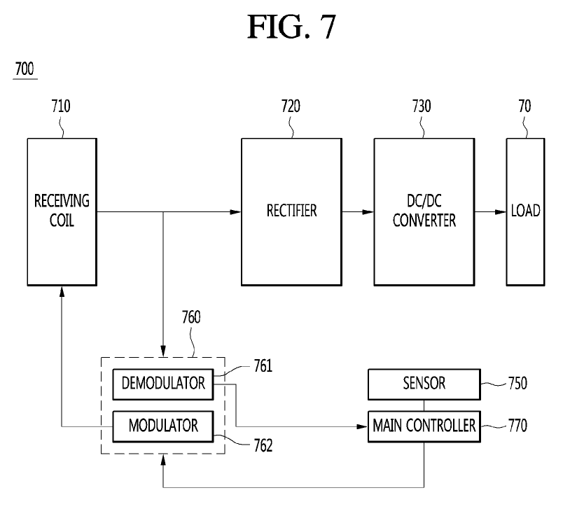

The wireless power receiver may transmit a predetermined charging mode packet to the wireless power transmitter 600 where the charging mode is set to fast charging if a fast charging is needed at any point of time in the power transfer phase. Here, the details of the configuration of the charging mode packet will be clarified through the description of FIGS. 7 to 11 to be described later. Of course, the wireless power transmitter 600 and the wireless power receiver can control the internal operation so that power corresponding to the fast charging mode can be sent and received when the charging mode is changed to the fast charging mode. For example, when the charging mode is changed from the normal low-power charging mode to the fast-charging mode, the overvoltage determination criterion, the over temperature criterion, the low-voltage/high-voltage determination criterion, the optimum voltage level), the power control offset, and the like can be changed and set.

For example, when the charging mode is changed from the normal low-power charging mode to the fast-charging mode, the threshold voltage for determining the overvoltage may be set to be high enough to enable fast charging. As another example, the critical temperature for determining whether overheating occurs may be set high considering the temperature rise due to fast charging. As still another example, the power control offset value, which means the minimum level at which the power at the transmitter is controlled, may be set to a larger value than the normal low power charging mode so that it can converge quickly to a desired target power level in the fast charging mode.

FIG. 7 is a block diagram for describing a structure of a wireless power receiver interworking with the wireless power transmitter of FIG. 6.

Referring to FIG. 7, a wireless power receiver 700 may include a receiving coil 710, a rectifier 720, a DC/DC converter 730, a load 740, a sensor 750, a communicator 760, and a main controller 770. Herein, the communicator 760 may include at least one of a demodulator 761 and a modulator 762.

The wireless power receiver 700 shown in the example of FIG. 7 exchanges information with the wireless power transmitter 600 through the In-band communication, but this is merely an embodiment. According to another embodiment the communicator 760 may perform the near field interactive communication through a frequency band different from the frequency band used in transmitting the wireless power signal.

The AC power received through the receiving coil 710 may be transferred to the rectifier 720. The rectifier 720 may convert the AC power into DC power and transmission it to the DC/DC converter 730. The DC/DC converter 730 may convert the level of the DC power output from the rectifier into a specific level required by the load 740 and then transmission it to the load 740. Further, the receiving coil 710 may include a plurality of receiving coil (not shown)—i.e., the first to nth receiving coils. According to one embodiment, frequencies of the AC power transferred to the receiving coils (not shown) may be different from each other. According to another embodiment, a predetermined frequency controller having a function of adjusting the receiving coils to have different LC resonance characteristics may be used to set the resonance frequencies of the receiving coils differently.

The sensor 750 may measure the level of the DC power output from the rectifier 720, and provides it to the main controller 770. Further, the sensor 750 may measure the intensity of the current applied to the receiving coil 710 in accordance with reception of the wireless power, and transmits the measured results to the main controller 770. Further, the sensor 750 may measure the internal temperature of the wireless power receiver 700, and provides the measured temperature value to the main controller 770.

For example, the main controller 770 may compare the measured level of the DC power output from the rectifier with a predetermined reference value, and determine whether an overvoltage is generated or not. As a result of determination, when the overvoltage is generated, the main controller 770 may make a predetermined packet for informing the overvoltage, and transmits the packet to the modulator 762. Herein, a signal modulated by the modulator 762 may be transmitted to the wireless power transmitter through the receiving coil 710 or a separate coil (not shown). Further, when the level of the DC power output from the rectifier is equal to or higher than a predetermined reference value, the main controller 770 may determine that a sensing signal is received, and control the signal strength indicator corresponding to the sensing signal can be transmitted to the wireless power transmitter through the modulator 762 when the sensing signal is received. Alternatively, the demodulator 761 may modulate a DC power signal output from the rectifier 720 or an AC power signal between the receiving coil 710 and the rectifier 720 and determine whether a sensing signal is received, thereby providing a determination result to the main controller 770. In this case, the main controller 770 may perform control so that the signal strength indicator corresponding to the sensing signal can be transmitted via the modulator 762.

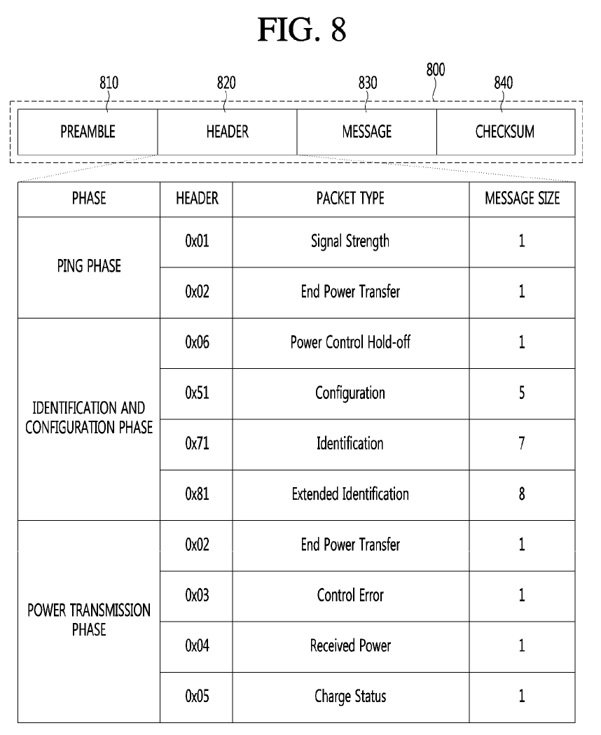

FIG. 8 is a view for describing a packet format in a wireless power transmission process of an electromagnetic induction manner according to one embodiment.

Referring to FIG. 8, a packet format 800 used in exchanging information between the wireless power transmitter and the wireless power receiver may be configured to include a field of a preamble 810 for obtaining a sync for demodulating a corresponding packet and identifying an accurate start bit of the corresponding packet; a field of a header 820 for identifying the kind of message included in the corresponding packet; a field of a message 830 for transmitting content (or payload) of the corresponding packet; and a field of a checksum 840 for identifying whether an error occurs in the corresponding packet.

As shown in FIG. 8, the packet receiver may identify the size of the message 830 included in the corresponding packet on the basis of the value of the header 820.

Further, the header 820 may be defined in each phase of the wireless power transmission process, and some headers 820 may have the same value in different phases but may be defined as different kinds of message. For example, referring to FIG. 8, the header corresponding to end power transmission in the ping phase and the header corresponding to end power transmission in the power transmission phase may have the same value of 0×02.

The message 830 includes data desired to be transmitted in the transmitter of the corresponding packet. For example, the data included in the field of the message 830 may include a report on the other party, a request, or a response without limitations.

According to another embodiment, the packet 700 may further include at least one of transmission terminal identification information for identifying a transmission terminal that transmits the corresponding packet, and receiving terminal identification information for identifying a receiving terminal that receives the corresponding packet. Herein, the transmission terminal identification information and the receiving terminal identification information may include Internet protocol (IP) address information, media access control (MAC) address information, product identification information, etc. without limitations as long as they can distinguish between the receiving terminal and the transmission terminal on the wireless system.

According to still another embodiment, the packet 800 may further include predetermined group identification information for identifying a corresponding receiving group in case that the corresponding packet has to be received in a plurality of apparatuses.

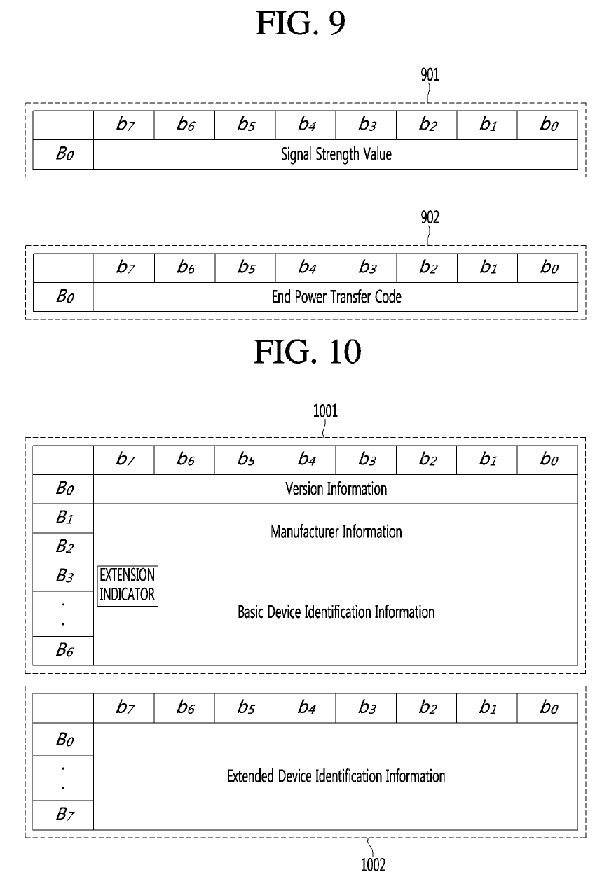

FIG. 9 is a view for describing the kind of packet transmittable in a ping phase by a wireless power receiving apparatus in the wireless power transmission process of an electromagnetic induction manner according to one embodiment.

As shown in FIG. 9, the wireless power receiver may transmit a signal strength packet or an end power transfer packet in the ping phase.

Referring the reference numeral of ‘901’ of FIG. 9, the message format of the signal strength packet according to one embodiment may be configured with a signal strength value having a size of 1 byte. The signal strength value may refer to a degree of coupling between the transmission coil and the receiving coil, and may be calculated on the basis of a rectifier output voltage in a digital ping section, an open circuit voltage measured in an output cut-off switch or the like, the level of the received power, etc. The signal strength value may range from 0 to 255, and may be 255 when a practical measurement value U of a specific variable is equal to the maximum value Umax of the corresponding variable.

For example, the signal strength value may be calculated by U/Umax*256.

Referring to the reference numeral of ‘902’ of FIG. 9, the message format of the end power transfer packet according to one embodiment may be configured with an end power transfer code having a size of 1 byte.

The reason why the wireless power receiving apparatus makes a request for the power transmission stop to the wireless power transmitter is because of charging complete, internal fault, over temperature, over voltage, over current, a battery failure, reconfiguration, no response, noise current, etc. without limitations. It will be appreciated that the end power transfer code may be additionally defined corresponding to new reasons of the power transmission stop.

The charge complete may be used when a receiver battery is fully charged. The Internal fault may be used when a software or logical error is sensed during an internal operation of the receiver.

The over temperature/over voltage/over current may be used when the temperature/voltage/current measured in the receiver exceed preset threshold values, respectively.

The battery failure may be used when it is determined that a problem arises in the receiver battery.

The reconfiguration may be used when renegotiation is needed with regard to power transmission conditions. The noise current may be noise generated at switching in an inverter unlike the over current, and may be used when the noise current measured in the receiver exceeds a defined threshold value.

FIG. 10 is a view for describing a message format of an identification packet in the wireless power transmission process of an electromagnetic induction according to one embodiment.

Referring to FIG. 10, the message format of the identification packet may include a field of version information, a field of manufacturer information, a field of extension indicator, and a field of basic device identification information.

The field of the version information may be recorded with revised version information of standards applied to the corresponding wireless power receiver.

The field of the manufacturer information may be recorded with a predetermined identification code for identifying a manufacturer that manufactures the corresponding wireless power receiver.

The field of the extension indicator field may be an indicator for identifying whether there is an extension identification packet including extended device identification information. For example, when the extension indicator has a value of 0, it means that the extension identification packet is not present. When the extension indicator has a value of 1, the extension identification packet is present after the identification packet.

Referring to the reference numerals of ‘1001’ to ‘1002’, when the extension indicator has a value of 0, a device identifier for the wireless power receiver may be achieved by combination of manufacturer information and basic device identification information. On the other hand, when the extension indicator has a value of 1, the device identifier for the wireless power receiver may be achieved by combination of manufacturer information, basic device identification information and extended device identification information.

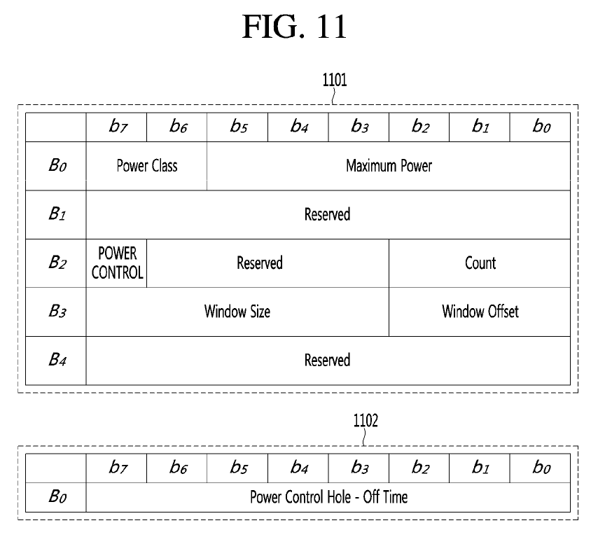

FIG. 11 is a view for describing message formats of a power control hold-off packet and a configuration packet in the wireless power transmission process of an electromagnetic induction manner according to one embodiment.

As shown in the reference numeral of ‘1101’ of FIG. 11, the message format of the configuration packet may have a length of 5 bytes, and may be configured with a field of a power class, a field of a maximum power, a field of power control, a field of count, a field of window size, a field of window offset, etc.

The field of the power class may be recorded with a power class assigned to the corresponding wireless power receiver.

The field of the maximum power may be recorded with the level of the maximum power provided by a rectifier output terminal of the wireless power receiver.

For example, in case that the power class is a and the maximum power is b, the maximum power amount Pmax desired to be output from the rectifier output terminal of the wireless power receiver may be calculated by (b/2)*10a.

The field of the power control may be used to indicate what algorithm the power control in the wireless power transmitter is performed by. For example, when the field of the power control has a value of 0, it means that the power control algorithm defined in the standards is applied. When the field of the power control has a value of 1, it means that the power control is performed by the algorithm defined by the manufacturer.

The field of the count may be used to record the number of option configuration packets transmittable by the wireless power receiver in the identification and configuration phase.

The field of the window size may be used to record the window size for calculating an average reception power. For example, the window size may be greater than 0 and have a positive integer given in units of 4 ms.

The field of the window offset may record information for identifying time from a termination time of an average reception power calculation window to a start time of transmitting the next reception power packet. For example, the window offset may be greater than 0 and have a positive integer given in units of 4 ms.

Referring to the reference numeral of ‘1102’, the message format of the power control hold-off packet may be configured to include power control hold-off time T delay. The power control hold-off packet may be transmitted in plural during the identification and configuration phase. For example, it is possible to transmit up to seven power control hold-off packets. The power control hold-off time T_delay may be in between the previously defined minimum power control hold-off time T_min of 5 ms and the maximum power control hold-off time T_max of 205 ms. The wireless power transmitter may perform the power control based on the power control hold-off time of the power control hold-off packet lastly received in the identification and configuration phase. Further, the wireless power transmitter may use T_min as T_delay when the power control hold-off packet is not received in the identification and configuration phase.

The power control hold-off time may refer to a time for which the wireless power transmitter has to stand by without performing the power control before actually performing the power control after receiving the latest control error packet.

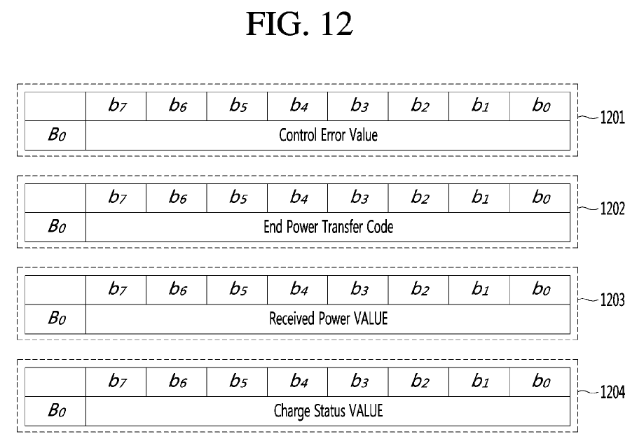

FIG. 12 is a view for describing the kind of packets transmittable in the power transmission phase by the wireless power receiving apparatus and their message formats in the wireless power transmission process of an electromagnetic induction manner according to one embodiment.

Referring to FIG. 12, the packet transmittable by the wireless power receiver in the power transmission phase may include a control error packet (CEP), an end power transfer packet, a reception power packet, a charge status packet, a packet defined according to manufacturers, etc.

The reference numeral of ‘1201’ shows a message format of the CEP configured with a control error value of 1 byte. Herein, the control error value may have an integer ranging from −128 to +127. When the control error value is negative, the transmission power of the wireless power transmitter may decrease. When the control error value is positive, the transmission power of the wireless power transmitter may increase.

The reference numeral of ‘1202’ shows a message format of the end power transfer packet configured with the end power transfer code of 1 byte.

The reference numeral of ‘1203’ shows a message format of the reception power packet configured with a received power value of 1 byte. Herein, the received power value may correspond to an average rectifier received power value calculated within a predetermined section. The actually received power amount (P_{received}) may be calculated based on the maximum power and the power class included in the configuration packet 1001. For example, the actually received power amount may be calculated by (received power value/128)*(the maximum power/2)*(10^{power class}).

The reference numeral of ‘1204’ shows a message format of the charge status packet configured with a charge status value of byte. The charge status value may indicate a battery charge amount of the wireless power receiver. For example, the charge status value of 0 means a fully discharged status, and a charge status value of 50 means a 50% charge status, and the charge status value of 100 may mean a fully charged status. When the wireless power receiving apparatus does not include a chargeable battery or provides no charge-status information, the charge status value may be set with OxFF.

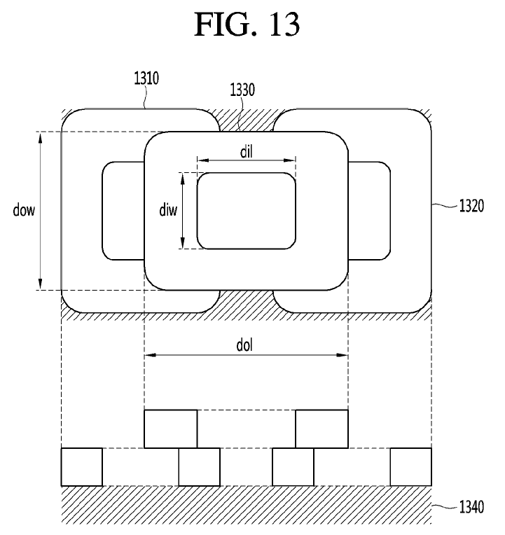

FIG. 13 is a view for describing arrangement of a plurality of coils and a distance from a shielding material according to one embodiment.

Referring to FIG. 13, a wireless power transmitter or a wireless power receiver may include a plurality of coils. For example, the number of coils may be three. In order to perform uniform power transmission or power reception within a constant-sized charging region, at least one of a plurality of coils may be disposed to be overlapped. In FIG. 13, a first coil 1310 and a second coil 1320 are disposed in parallel on a first layer of a shielding material 1340 at regular intervals, and a third coil 1330 may be disposed to be overlapped on a second layer above the first coil 1310 and the second coil 1320.

The first coil 1310, the second coil 1320, and the third coil 1330 may be manufactured according to specifications of a coil defined by the WPC or the PMA in the case of a coil disposed in a wireless power transmitter, and may be the same within a range to which each physical characteristic may be allowable.

For example, a coil of a wireless power transmitter may have the same specifications as in Table 1 below.

TABLE 1

| Parameter | Symbol | Value |
|---|---|---|
| Outer length | dol | 53.2 ± 0.5 mm |
| Inner length | dil | 27.5 ± 0.5 mm |
| Outer width | dow | 45.2 ± 0.5 mm |
| Inner width | diw | 19.5 ± 0.5 mm |
| Thickness | dc | 1.5 ± 0.5 mm |
| Number of turns per layer | N | 12 turns |
| Number of layers | | 1 |

Table 1 is a specification for a coil of the A13 type wireless power transmitter defined in the WPC. In one embodiment, the first coil 1310, the second coil 1320, and the third coil 1330 may be manufactured by an outer length, an inner length, an outer width, an inner width, a thickness, and a number of turns defined in Table 1. Of course, the first coil 1310, the second coil 1320, and the third coil 1330 may have the same physical characteristics within an error range by the same manufacturing process.

For example, the first coil 1310 and the second coil 1320 may be disposed such that respective surfaces thereof is in contact with the shielding material, while the third coil 1330 may be disposed to be separated from the shielding material by a predetermined height.

The third coil 1330 located at the center is located farther from the shielding material than the first coil 1310 and the second coil 1320 so that the measured inductance is different from those of the first coil 1310 and the second coil 1320, and thus it is possible to be adjust the inductance to be the same as the inductances of the first coil 1310 and the second coil 1320 by making a length of a conductive wire constituting the third coil 1330 slightly longer than those of the first coil 1310 and the second coil.

In one embodiment, even though the third coil 1330 is located farther from the shielding material than the first coil 1330 and the second coil 1320, inductances of the three coils may be equal to 12.5 uH by making the length of the conductive wire constituting the third coil 1330 slightly longer than those of the first coil 1210 and the second coil 1320. In one embodiment, the same inductance of a coil means having an error range within +1-0.5 uH.

As a distance to the shielding material increases, a measured inductance of a coil located to be overlapped may be smaller. As the distance to the shielding material increases, a length of a coil located to be overlapped may be made longer to increase the inductance.

Meanwhile, when inductances of the first coil 1310, the second coil 1320, and the third coil 1330 are different from each other, a resonance circuit including capacitors different from each other depending on each of inductances and each drive circuit capable of controlling a resonance frequency generated from the resonance circuit may be required.

In one embodiment, an adhesive (not shown) may be disposed between the first coil 1310, the second coil 1320, or the third coil 1330 and the shielding material.

Therefore, there is a problem that a configuration such as a separate adhesive is required to fix a plurality of coils of a wireless power transmitter and receiver according to an embodiment. Further, there is a problem that a plurality of coils of a wireless power transmitter and receiver according to an embodiment are separated from a fixed position by an external impact.

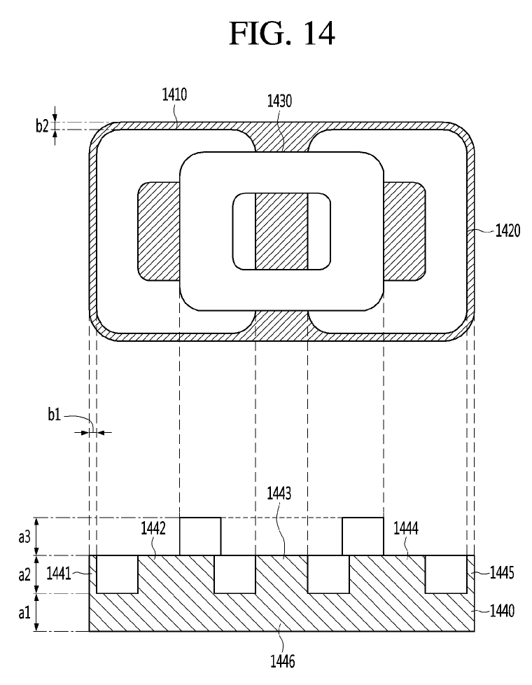

FIG. 14 is a view for describing a configuration in which one or more coils and a shielding material are integrated according to another embodiment.

Referring to FIG. 14, a wireless power transmitter or a wireless power receiver according to another embodiment may include a plurality of coils. For example, the number of coils may be three. In addition, at least one of the plurality of coils may be disposed to be overlapped in order to perform uniform power transmission or power reception within a constant-sized charging region. For example, a first coil 1410, a second coil 1420, and a third coil 1430 may be manufactured with an outer length, an inner length, an outer width, an inner width, a thickness, and the number of windings, which are defined in Table 1. The first coil 1410 and the second coil 1420 are disposed in parallel on a second layer a2 of a shielding material 1440 at regular intervals, and the third coil 1430 may be disposed to be overlapped on a third layer a3 located above the shielding material 1440, the first coil 1410, and the second coil 1420. The first to third coils 1410 to 1430 may all be disposed in the same direction, and one of the coils may be disposed in another direction. For example, as shown in FIG. 14, the first coil 1410 and the second coil 1420 may be disposed in the same direction and the third coil 1430 may be disposed in the 90-degree direction of the first coil 1410 or the second coil 1420.

In another embodiment, a third coil 1430 may be fixed to a first coil 1410, a second coil 1420, or a shielding material 1440 by an adhesive (not shown).

A wireless power transmitter or a wireless power receiver according to another embodiment may include a shielding material 1440 integrated with one or more coils. The shielding material 1440 may include an alloy or ferrite made of a combination of one or more elements selected from the group consisting of Fe, Ni, Co, Mn, Al, Zn, Cu, Ba, Ti, Sn, Sr, P, B, N, C, W, Cr, Bi, Li, Y, Cd, and the like.

In addition, the shielding material 1440 may have an area larger than the area in which the plurality of coils are disposed. For example, the shielding material 1440 may be disposed in an area larger than the area in which the first coil 1410 and the second coil 1420 are disposed. More specifically, as shown in FIG. 14, the shielding material 1440 may be disposed to extend at a first distance 131 from a longitudinal outer side of the first coil 1410 or the second coil 1420. The shielding material 1440 may be disposed to extend at a second distance b2 from a lateral outer side of the first coil 1410 or the second coil 1420. The first distance b1 and the second distance b2 may have the same length or may be different from each other. More specifically, when the lengths are the same, the first distance b1 or the second distance b2 may be 1 mm to 1.5 mm. The shielding material 1440 disposed larger than the first coil 1410 or the second coil 1420 may guide in a charging direction a magnetic field generated from the first coil 1410 or the second coil 1420. Further, the shielding material 1440 disposed larger than the first coil 1410 or the second coil 1420 may guide in the charging direction a magnetic field received to the first coil 1410 or the second coil 1420. Accordingly, the first distance b1 or the second distance b2 is not limited to the length, as long as it has a length enough to guide the magnetic field of the coil.

In addition, in a wireless power transmitter or wireless power receiver according to another embodiment, the shielding material 1440 may be integrated with one or more coils. For example, as shown in FIG. 14, the shielding material 1440 may be disposed on a first layer a1. The shielding material 1440, the first coil 1410, and the second coil 1420 may be disposed on a second layer a2. The third coil 1430 may be disposed on a third layer a3. Further, the shielding material 1440 may include first to sixth regions 1441 to 1446. The first region 1441 may be located in the second layer a2 and disposed outside the first coil 1410. The second region 1442 may be located in the second layer a2 and disposed inside the first coil 1410. The third region 1443 may be located in the second layer a2 and disposed between an outside of the first coil 1410 and an outside of the second coil 1420. The fourth region 1444 may be located in the second layer a2 and disposed inside the second coil 1420. The fifth region 1445 may be located in the second layer a2 and disposed outside the second coil 1420. The sixth region 1446 may be located in the first layer a1. That is, the sixth region 1446 may include all of the first layer a1 in which only the shielding material 1440 is disposed.

Accordingly, the first coil 1410 or the second coil 1420 may be fixed by the first to fifth regions 1441 to 1445 of the shielding material 1440 without an adhesive. In addition, the first coil 1410 or the second coil 1420 may be protected from an external impact by the first to fifth regions 1441 to 1445 of the shielding material 1440. In addition, the first coil 1410 or the second coil 1420 may have improved heat resistance characteristics by the first to fifth regions 1441 to 1445 of the shielding material. The first to fifth regions 1441 to 1445 of the shielding material 1440 may guide in the charging direction a magnetic field transmitted or received by the first coil 1410 or the second coil 1420. The third coil 1430 may be in contact with the first to fifth regions 1441 to 1445 of the shielding material 1440, so that inductance of the third coil 1430 may be increased. That is, the third coil 1430 may be in contact with the first to fifth regions 1441 to 1445 of the shielding material 1440, so that the inductance of the third coil 1430 may be adjusted to be the same as the inductances of the first coil 1410 and the second coil 1420. Further, when the third coil 1430 is disposed in the 90-degree direction of the first coil 1410 or the second coil 1420, an area in which the third coil 1430 is in contact with the shielding material 1440 is widened, and thus the inductance of the third coil 1430 may be further increased.

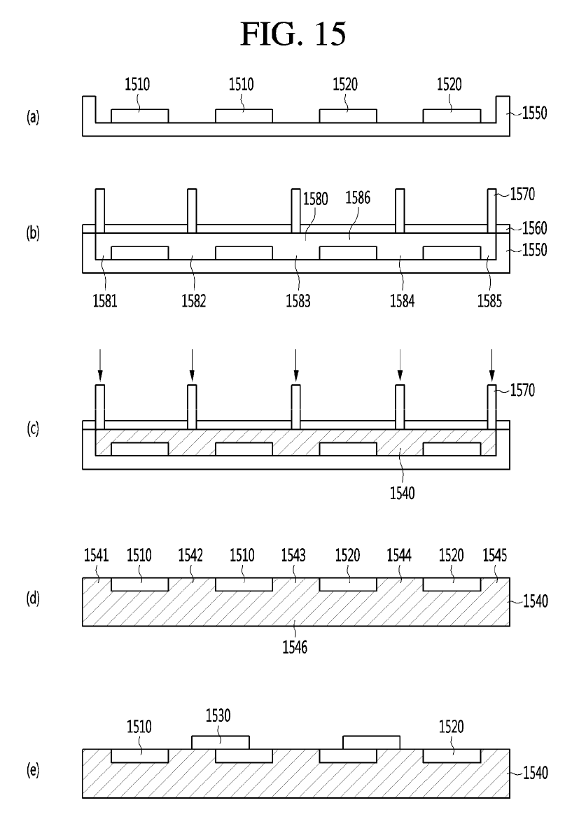

FIG. 15 is a view for describing a method of manufacturing integrated one or more coils and a shielding material in another embodiment according to FIG. 14.

FIGS. 15A to 15E are process flowcharts showing a method of manufacturing integrated one or more coils and a shielding material in another embodiment.

Referring to FIG. 15, a method of manufacturing integrated one or more coils and a shielding material according to another embodiment may include a step (a) of disposing a first coil 1510 and a second coil 1520 in a lower mold 1550. The lower mold 1550 may include a side surface and a bottom surface. The bottom surface may be a flat surface without a groove. The first coil 1510 and the second coil 1520 may be disposed on the bottom surface of the lower mold 1550.

The method of manufacturing integrated one or more coils and a shielding material according to another embodiment may include a step (b) of forming a cavity 1580 by disposing an upper mold 1560 on the lower mold 1550.

The cavity 1580 may be an inner space filled with a shielding material in a state of liquid or powder which is a casting material. For example, as shown in FIG. 15B, the cavity 1570 may include first to sixth regions 1581 to 1586. The first region 1581 of the cavity may be a space between a side surface of the lower mold 1550 and an outside of the first coil 1510. The second region 1582 of the cavity may be a space of an inside of the first coil 1510. The third region 1583 of the cavity may be a space between the outside of the first coil 1510 and an outside of the second coil 1520. The fourth region 1584 of the cavity may be a space of an inside of the second coil 1520. The fifth region 1585 of the cavity may be a space between the outside of the second coil 1520 and the side surface of the lower mold 1550. The sixth region 1586 of the cavity may be upper spaces of the first coil 1510 and the second coil 1520. That is, the sixth region 1586 of the cavity may be a space of a layer in which the first coil 1510 and the second coil 1520 are not disposed.

A gate 1570 may be a passage for injecting a shielding material in a state of liquid or powder which is a casting material into the cavity 1580. The gate 1570 may be one or more. The gate 1570 may be disposed to be integrated with the upper mold 1560, and connected through holes (not shown) disposed in the upper mold 1560. The gate 1570 is described as being included in the upper mold 1560 in another embodiment, but may be included in the lower mold 1550. That is, the gate may be disposed to be integrated with the lower mold, and connected through holes disposed in the lower mold (not shown). A plurality of gates 1570 may be disposed to correspond to the first to fifth regions 1581 to 1585 of the cavity.

The method of manufacturing integrated one or more coils and a shielding material according to another embodiment may include a step (c) of filling the cavity 1580 by injecting a shielding material 1540 in a state of liquid or powder which is a casting material into one or more gates 1570. That is, a molding process such as transfer molding or injection molding may be used to integrally form one or more coils and a shielding material. The method of manufacturing integrated one or more coils and a shielding material according to another embodiment may include a step (not shown) of curing the injected shielding material 1540.

The method of manufacturing integrated one or more coils and a shielding material according to another embodiment may include a step (d) of removing the lower mold 1550 and the upper mold 1560 when the shielding material 1540 is cured. Accordingly, the shielding material and one or more coils may be integrated. In FIG. 15D, first to sixth regions 1541 to 1546 of the shielding material may correspond to the first to sixth regions 1581 to 1586 of the cavity in FIG. 15B. In the shielding material 1540, a burr (not shown) in an embossed or depressed shape may be generated by corresponding to the gate 1570 into which a casting material is injected after removing the lower mold 1550 and the upper mold 1560. When an embossed burr is generated, a step of cutting the embossed burr may be added.

The method of manufacturing integrated one or more coils and a shielding material according to another embodiment may include a step of (e) of disposing a third coil 1530 to be overlapped with upper surfaces of the shielding material 1540, the first coil 1510, and the second coil 1520. At this time, the third coil 1530 may be fixed to the first coil 1510, the second coil 1520, or the shielding material 1540 by an adhesive (not shown).

Accordingly, outside, inside, and bottom surface of the first coil 1410 or 1510 and the second coil 1420 or 1520 may be in contact with the shielding material 1440 or 1540. Further, a portion of outside of the third coil 1430 or 1530 may be in contact with the shielding material 1440 or 1540. That is, the first coil 1410 or 1510, the second coil 1420 or 1520, and the third coil 1430 or 1530 may be integrally formed with the shielding material 1440 or 1540.

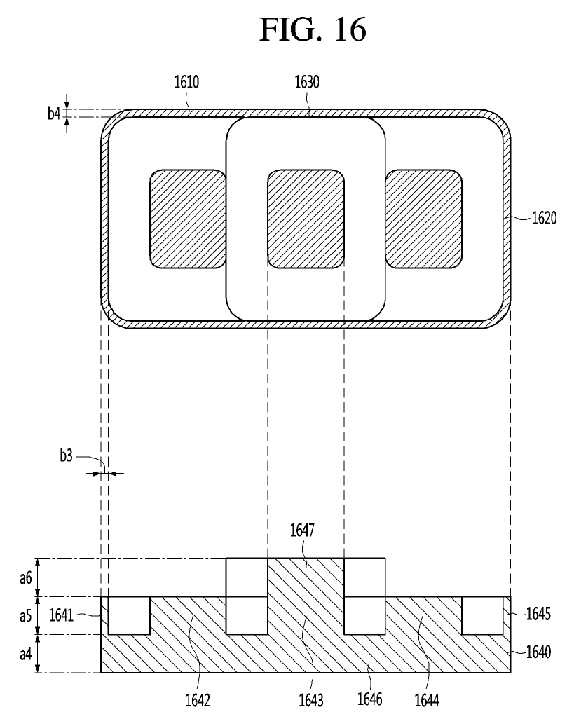

FIG. 16 is a view for describing a configuration in which one or more coils and a shielding material are integrated according to still another embodiment.

Referring to FIG. 16, a wireless power transmitter or a wireless power receiver according to still another embodiment may include a plurality of coils. For example, the number of coils may be three. In addition, at least one of the plurality of coils may be disposed to be overlapped in order to perform uniform power transmission or power reception within a constant-sized charging region. For example, a first coil 1610, a second coil 1620, and a third coil 1630 may be manufactured with an outer length, an inner length, an outer width, an inner width, a thickness, and the number of windings, which are defined in Table 1. The first coil 1610 and the second coil 1620 are disposed in parallel on a second layer a2 of a shielding material 1640 at regular intervals, and the third coil 1630 may be disposed to be overlapped on a third layer a3 located above the shielding material 1640, the first coil 1610, and the second coil 1620. The first to third coils 1610 to 1630 may all be disposed in the same direction, and one of the coils may be disposed in another direction. For example, as shown in FIG. 16, the first to third coils 1610 to 1630 may be disposed in the same direction.

In still another embodiment, a third coil 1630 may be fixed to a first coil 1610, a second coil 1620, or a shielding material 1640 by an adhesive (not shown).

A wireless power transmitter or a wireless power receiver according to still another embodiment may include a shielding material 1640 integrated with one or more coils. The shielding material 1440 may include an alloy or ferrite made of a combination of one or more elements selected from the group consisting of Fe, Ni, Co, Mn, Al, Zn, Cu, Ba, Ti, Sn, Sr, P, B, N, C, W, Cr, Bi, Li, Y, Cd, and the like.

In addition, the shielding material 1640 may have an area larger than the area in which the plurality of coils are disposed. For example, the shielding material 1640 may be disposed in an area larger than the area in which the first coil 1610 and the second coil 1620 are disposed. More specifically, as shown in FIG. 16, the shielding material 1640 may be disposed to extend at a first distance b3 from a longitudinal outer side of the first coil 1610 or the second coil 1620. The shielding material 1640 may be disposed to extend at a second distance b4 from a lateral outer side of the first coil 1610 or the second coil 1620. The first distance b3 and the second distance b4 may have the same length or may be different from each other. More specifically, when the lengths are the same, the first distance b3 or the second distance b4 may be 1 mm to 1.5 mm. The shielding material 1640 disposed larger than the first coil 1610 or the second coil 1620 may guide in a charging direction a magnetic field generated from the first coil 1610 or the second coil 1620. Further, the shielding material 1640 disposed larger than the first coil 1610 or the second coil 1620 may guide in the charging direction a magnetic field received to the first coil 1610 or the second coil 1620. Accordingly, the first distance b3 or the second distance b4 is not limited to the length, as long as it has a length enough to guide the magnetic field of the coil.

In addition, in a wireless power transmitter or wireless power receiver according to another embodiment, the shielding material 1640 may be integrated with one or more coils. For example, as shown in FIG. 16, the shielding material 1640 may be disposed on a first layer a4. The shielding material 1640, the first coil 1610, and the second coil 1620 may be disposed on a second layer a5. The shielding material 1640 and the third coil 1630 may be disposed on a third layer a6. Further, the shielding material 1640 may include first to seventh regions 1641 to 1647. The first region 1641 may be located in the second layer a5 and disposed outside the first coil 1610. The second region 1642 may be located in the second layer a2 and disposed inside the first coil 1610. The third region 1643 may be located in the second layer a5 and disposed between an outside of the first coil 1610 and an outside of the second coil 1620. The fourth region 1644 may be located in the second layer a5 and disposed inside the second coil 1620. The fifth region 1645 may be located in the second layer a5 and disposed outside the second coil 1620. The sixth region 1646 may be located in the first layer a4. That is, the sixth region 1646 may include all of the first layer a4 in which only the shielding material 1640 is disposed. The seventh region 1647 may be located in the third layer a6 and disposed inside the third coil 1630. That is, the seventh region 1647 may be disposed inside the third coil 1630 to extend from the third region 1643.

Accordingly, the first coil 1610 or the second coil 1620 may be fixed by the first to fifth regions 1641 to 1645 of the shielding material 1640 without an adhesive. In addition, the third coil 1630 may have an increased fixing force by the seventh region 1647 of the shielding material disposed therein. Further, the first coil 1610 or the second coil 1620 may be protected from an external impact by the first to fifth regions 1641 to 1645 of the shielding material 1640. In addition, the first coil 1610 or the second coil 1460 may have improved heat resistance characteristics by the first to fifth regions 1641 to 1645 of the shielding material 1640. Further, the third coil 1630 may have improved heat resistance characteristics by the seventh region 1647 of the shielding material 1640. In addition, the first to seventh regions 1641 to 1647 of the shielding material 1640 may guide in the charging direction a magnetic field transmitted or received by the first coil 1610 or the second coil 1620. Further, the third coil 1630 may be in contact with the seventh region 1647 of the shielding material 1640, so that inductance of the third coil 1630 may be increased. That is, the third coil 1630 may be in contact with the seventh region 1647 of the shielding material 1640, so that the inductance of the third coil 1630 may be adjusted to be the same as the inductances of the first coil 1610 and the second coil 1620.

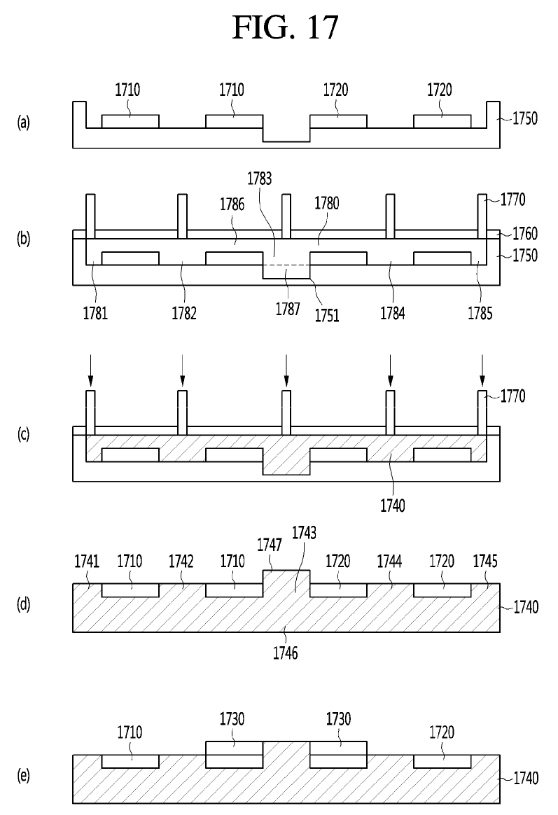

FIG. 17 is a view for describing a method of manufacturing integrated one or more coils and a shielding material in still another embodiment according to FIG. 16.

FIGS. 17A to 17E are process flowcharts showing a method of manufacturing integrated one or more coils and a shielding material in another embodiment.

Referring to FIG. 17, a method of manufacturing integrated one or more coils and a shielding material according to still another embodiment may include a step (a) of disposing a first coil 1710 and a second coil 1720 in a lower mold 1750. The lower mold 1750 may include a side surface and a bottom surface. The first coil 1510 and the second coil 1520 may be disposed on the bottom surface of the lower mold 1550. The bottom surface may include a groove 1751. The groove 1751 may be disposed between an outside of the first coil 1710 and an outside of the second coil 1720. The groove 1751 may have a shape corresponding to an inner shape of the third coil 1730. A depth of the groove 1741 may be equal to a thickness of the third coil 1730.

The method of manufacturing integrated one or more coils and a shielding material according to still another embodiment may include a step (b) of forming a cavity 1780 by disposing an upper mold 1760 on the lower mold 1750.

The cavity 1780 may be an inner space filled with a shielding material in a state of liquid or powder which is a casting material. For example, as shown in FIG. 17B, the cavity 1770 may include first to seventh regions 1781 to 1787. The first region 1781 of the cavity may be a space between a side surface of the lower mold 1750 and an outside of the first coil 1710. The second region 1782 of the cavity may be a space of an inside of the first coil 1710. The third region 1783 of the cavity may be a space between the outside of the first coil 1710 and an outside of the second coil 1720. The fourth region 1784 of the cavity may be a space of an inside of the second coil 1720. The fifth region 1785 of the cavity may be a space between the outside of the second coil 1720 and the side surface of the lower mold 1750. The sixth region 1786 of the cavity may be upper spaces of the first coil 1710 and the second coil 1720. That is, the sixth region 1786 of the cavity may be a space of a layer in which the first coil 1710 and the second coil 1720 are not disposed. The seventh region 1787 of the cavity may be a space disposed by the groove 1751 of the lower mold. That is, the seventh region 1787 of the cavity may be a space disposed to extend from the third region 1731 of the cavity.

A gate 1770 may be a passage for injecting a shielding material in a state of liquid or powder which is a casting material into the cavity 1780. The gate 1770 may be one or more. The gate 1770 may be disposed to be integrated with the upper mold 1760, and connected through holes (not shown) disposed in the upper mold 1760. The gate 1770 is described as being included in the upper mold 1760 in still another embodiment, but may be included in the lower mold 1750. That is, the gate may be disposed to be integrated with the lower mold, and connected through holes disposed in the lower mold (not shown). A plurality of gates 1770 may be disposed to correspond to the first to fifth regions 1781 to 1785 of the cavity.

The method of manufacturing integrated one or more coils and a shielding material according to another embodiment may include a step (c) of filling the cavity 1780 by injecting a shielding material 1740 in a state of liquid or powder which is a casting material into one or more gates 1770. That is, a molding process such as transfer molding or injection molding may be used to integrally form one or more coils and a shielding material.

The method of manufacturing integrated one or more coils and a shielding material according to still another embodiment may include a step (not shown) of curing the injected shielding material 1740.

The method of manufacturing integrated one or more coils and a shielding material according to still another embodiment may include a step (d) of removing the lower mold 1750 and the upper mold 1760 when the shielding material 1740 is cured. Accordingly, the shielding material and one or more coils may be integrated. In FIG. 17D, first to seventh regions 1741 to 1747 of the shielding material may correspond to the first to seventh regions 1781 to 1787 of the cavity in FIG. 17B. In the shielding material 1740, a burr (not shown) in an embossed or depressed shape may be generated by corresponding to the gate 1770 into which a casting material is injected after removing the lower mold 1750 and the upper mold 1760. When an embossed burr is generated, a step of cutting the embossed burr may be added.

The method of manufacturing integrated one or more coils and a shielding material according to still another embodiment may include a step of (e) of disposing a third coil 1730 to be overlapped with upper surfaces of the shielding material 1740, the first coil 1710, and the second coil 1720. At this time, the third coil 1730 may be fixed to the first coil 1710, the second coil 1720, or the shielding material 1740 by an adhesive (not shown).

Accordingly, outside, inside, and bottom surface of the first coil 1610 or 1710 and the second coil 1620 or 1720 may be in contact with the shielding material 1640 or 1740. Further, a portion of outside of the third coil 1630 or 1730 may be in contact with the shielding material 1640 or 1740. That is, the first coil 1610 or 1710, the second coil 1620 or 1720, and the third coil 1630 or 1730 may be integrally formed with the shielding material 1640 or 1740.

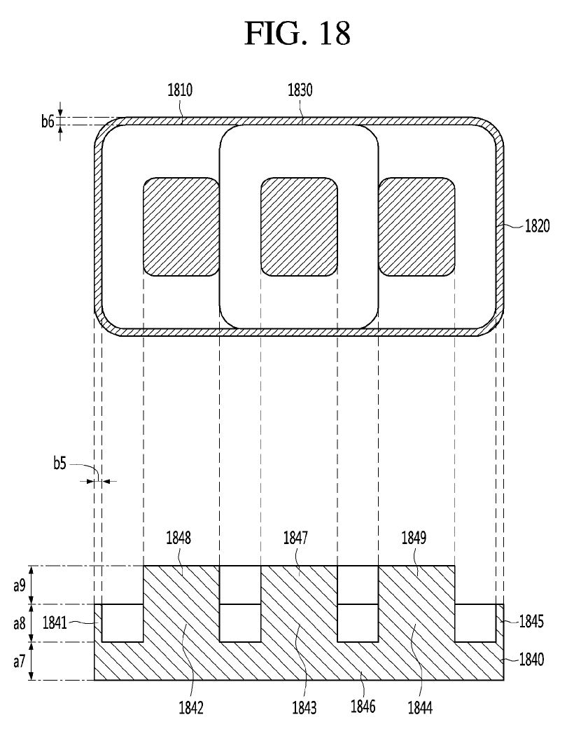

FIG. 18 is a view for describing a configuration in which a plurality of coils and a shielding material are integrated according to still another embodiment.

Referring to FIG. 18, a wireless power transmitter or a wireless power receiver according to still another embodiment may include a plurality of coils. For example, the number of coils may be three. In addition, at least one of the plurality of coils may be disposed to be overlapped in order to perform uniform power transmission or power reception within a constant-sized charging region. For example, a first coil 1810, a second coil 1820, and a third coil 1830 may be manufactured with an outer length, an inner length, an outer width, an inner width, a thickness, and the number of windings, which are defined in Table 1. The first coil 1810 and the second coil 1820 are disposed in parallel on a second layer a8 of a shielding material 1840 at regular intervals, and the third coil 1830 may be disposed to be overlapped on a third layer a9 located above the shielding material 1840, the first coil 1810, and the second coil 1820. The first to third coils 1810 to 1830 may all be disposed in the same direction, and one of the coils may be disposed in another direction. For example, as shown in FIG. 18, the first to third coils 1810 to 1830 may be disposed in the same direction.

A wireless power transmitter or a wireless power receiver according to still another embodiment may include a shielding material 1640 integrated with one or more coils. The shielding material 1440 may include an alloy or ferrite made of a combination of one or more elements selected from the group consisting of Fe, Ni, Co, Mn, Al, Zn, Cu, Ba, Ti, Sn, Sr, P, B, N, C, W, Cr, Bi, Li, Y, Cd, and the like.

In addition, the shielding material 1840 may have an area larger than the area in which the plurality of coils are disposed. For example, the shielding material 1840 may be disposed in an area larger than the area in which the first coil 1810 and the second coil 1820 are disposed. More specifically, as shown in FIG. 18, the shielding material 1840 may be disposed to extend at a first distance b5 from a longitudinal outer side of the first coil 1810 or the second coil 1820. The shielding material 1840 may be disposed to extend at a second distance b6 from a lateral outer side of the first coil 1810 or the second coil 1820. The first distance b5 and the second distance b6 may have the same length or may be different from each other. More specifically, when the lengths are the same, the first distance b5 or the second distance b6 may be 1 mm to 1.5 mm. The shielding material 1840 disposed larger than the first coil 1810 or the second coil 1820 may guide in a charging direction a magnetic field generated from the first coil 1810 or the second coil 1820. Further, the shielding material 1840 disposed larger than the first coil 1810 or the second coil 1820 may guide in the charging direction a magnetic field received to the first coil 1810 or the second coil 1820. Accordingly, the first distance b5 or the second distance b6 is not limited to the length, as long as it has a length enough to guide the magnetic field of the coil.

In addition, in a wireless power transmitter or wireless power receiver according to another embodiment, the shielding material 1840 may be integrated with one or more coils. For example, as shown in FIG. 18, the shielding material 1840 may be disposed on a first layer a7. The shielding material 1840, the first coil 1810, and the second coil 1820 may be disposed on a second layer a8. The shielding material 1840 and the third coil 1830 may be disposed on a third layer a9. Further, the shielding material 1840 may include first to ninth regions 1841 to 1849. The first region 1841 may be located in the second layer a8 and disposed outside the first coil 1810. The second region 1842 may be located in the second layer a8 and disposed inside the first coil 1810. The third region 1843 may be located in the second layer a8 and disposed between an outside of the first coil 1810 and an outside of the second coil 1820. The fourth region 1844 may be located in the second layer a8 and disposed inside the second coil 1820. The fifth region 1845 may be located in the second layer a8 and disposed outside the second coil 1820. The sixth region 1846 may be located in the first layer a7. That is, the sixth region 1846 may include all of the first layer a7 in which only the shielding material 1840 is disposed. The seventh region 1847 may be located in the third layer a9 and disposed inside the third coil 1830. That is, the seventh region 1847 may be disposed inside the third coil 1830 to extend from the third region 1843. The eighth region 1848 may be located in the third layer a9 and disposed outside the third coil 1830. That is, the eighth region 1848 may be disposed outside the third coil 1830 to extend from the second region 1842 disposed inside the first coil 1810. The ninth region 1849 may be located in the third layer a9 and disposed outside the third coil 1830. That is, the ninth region 1849 may be disposed outside the third coil 1830 to extend from the fourth region 1844 disposed inside the second coil 1820.

Accordingly, the first coil 1810 to the third coil 1830 may be fixed by the first to ninth regions 1841 to 1849 of the shielding material without an adhesive. In addition, the first to third coils 1810 to 1830 may be protected from an external impact by the first to ninth regions 1841 to 1849 of the shielding material. Further, the first to third coils 1810 to 1830 may have improved heat resistance characteristics by the first to fifth regions 1841 to 1849 of the shielding material 1640. In addition, the first to ninth regions 1841 to 1849 of the shielding material may guide in the charging direction a magnetic field transmitted or received by the first to third coils 1810 to 1830. Further, the third coil 1630 may be in contact with the seventh to ninth regions 1847 to 1849 of the shielding material, so that inductance of the third coil 1830 may be increased. That is, the third coil 1830 may be in contact with the seventh to ninth regions 1847 to 1849 of the shielding material, so that the inductance of the third coil 1830 may be adjusted to be the same as the inductances of the first coil 1810 and the second coil 1820.

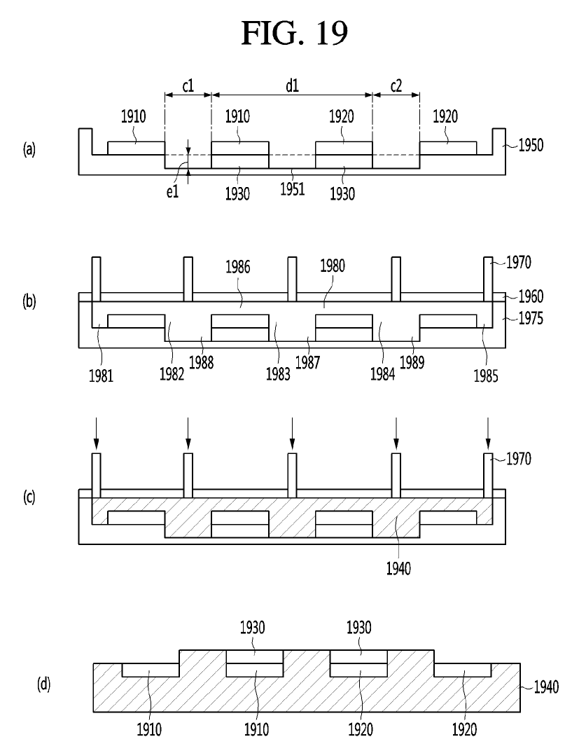

FIG. 19 is a view for describing a method of manufacturing integrated one or more coils and a shielding material in still another embodiment according to FIG. 18.

FIGS. 19A to 19E are process flowcharts showing a method of manufacturing integrated one or more coils and a shielding material in still another embodiment.

Referring to FIG. 19, a method of manufacturing integrated one or more coils and a shielding material according to still another embodiment may include a step (a) of disposing a first coil 1910 to a third coil 1930 in a lower mold 1950. The lower mold 1950 may include a side surface and a bottom surface. The bottom surface may include a groove 1951. A diameter of the groove 1951 may be a length of sum of an inner length c1 of the first coil 1910, an inner length c2 of the second coil 1920, and an outer length d1 of the third coil 1930. A depth e1 of the groove may be equal to a thickness of the third coil 1930. The third coil 1930 may be disposed in the groove 1951. The first coil 1910 may be disposed to be overlapped on the bottom surface of the lower mold 1950 and the third coil 1930. The second coil 1920 may be disposed to be overlapped on the bottom surface of the lower mold 1950 and the third coil 1930.

The method of manufacturing integrated one or more coils and a shielding material according to still another embodiment may include a step (b) of forming a cavity 1980 by disposing an upper mold 1960 on the lower mold 1950.

The cavity 1980 may be an inner space filled with a shielding material in a state of liquid or powder which is a casting material. For example, as shown in FIG. 19B, the cavity may include first to ninth regions 1981 to 1989. The first region 1981 of the cavity may be a space between a side surface of the lower mold 1950 and an outside of the first coil 1910. The second region 1982 of the cavity may be a space of an inside of the first coil 1910. The third region 1983 of the cavity may be a space between the outside of the first coil 1910 and an outside of the second coil 1920. The fourth region 1984 of the cavity may be a space of an inside of the second coil 1920. The fifth region 1985 of the cavity may be a space between the outside of the second coil 1920 and the side surface of the lower mold 1950. The sixth region 1986 of the cavity may be upper spaces of the first coil 1910 and the second coil 1920. That is, the sixth region 1986 of the cavity may be a space of a layer in which the first to third coils 1910 to 1930 are not disposed. The seventh region 1987 of the cavity may be disposed in the groove 1951 of the lower mold and may be space of an inside of the third coil 1930.

A gate 1970 may be a passage for injecting a shielding material in a state of liquid or powder which is a casting material into the cavity 1980. The gate 1970 may be one or more. The gate 1970 may be disposed to be integrated with the upper mold 1960, and connected through holes (not shown) disposed in the upper mold 1960. The gate 1970 is described as being included in the upper mold 1960 in still another embodiment, but may be included in the lower mold 1950. That is, the gate may be disposed to be integrated with the lower mold, and connected through holes disposed in the lower mold (not shown). A plurality of gates 1970 may be disposed to correspond to the first to fifth regions 1981 to 1985 of the cavity.

The method of manufacturing integrated one or more coils and a shielding material according to another embodiment may include a step (c) of filling the cavity 1980 by injecting a shielding material 1940 in a state of liquid or powder which is a casting material into one or more gates 1970. That is, a molding process such as transfer molding or injection molding may be used to integrally form one or more coils and a shielding material.

The method of manufacturing integrated one or more coils and a shielding material according to still another embodiment may include a step (not shown) of curing the injected shielding material 1940.

The method of manufacturing integrated one or more coils and a shielding material according to still another embodiment may include a step (d) of removing the lower mold 1950 and the upper mold 1960 when the shielding material 1940 is cured. Accordingly, the shielding material and one or more coils may be integrated. In FIG. 19D, first to ninth regions 1941 to 1949 of the shielding material may correspond to the first to ninth regions 1981 to 1989 of the cavity in FIG. 19B.

In addition, in the shielding material 1940, a burr (not shown) in an embossed or depressed shape may be generated by corresponding to the gate 1970 into which a casting material is injected after removing the lower mold 1950 and the upper mold 1960. When an embossed burr is generated, a step of cutting the embossed burr may be added.

Accordingly, outside, inside, and bottom surface of the first coil 1810 or 1910 and the second coil 1820 or 1920 may be in contact with the shielding material 1840 or 1940. Further, a portion of outside of the third coil 1830 or 1930 may be in contact with the shielding material 1840 or 1940. That is, the first coil 1810 or 1910, the second coil 1820 or 1920, and the third coil 1830 or 1930 may be integrally formed with the shielding material 1840 or 1940.

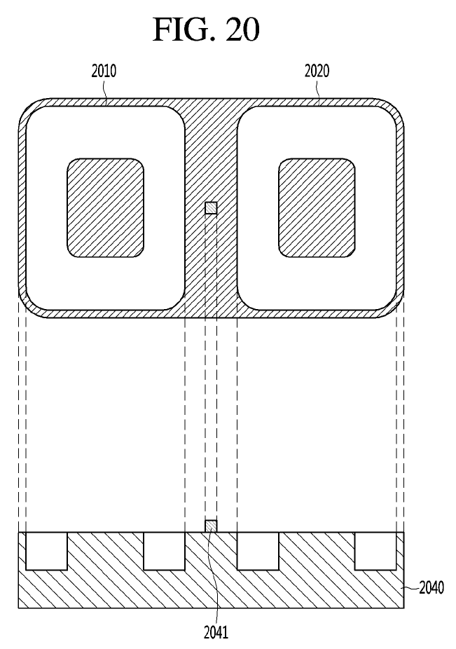

FIG. 20 is a view for describing a shielding material-integrated type wireless charging coil and a manufacturing method thereof according to one embodiment.

In the following description, except for overlapping descriptions of a shielding material-integrated type wireless charging coil and a manufacturing method thereof according to FIGS. 14, 16, and 18, a difference between configurations will be mainly described.

Referring to FIG. 20, one or more coils of a plurality of coils may be integrated with a shielding material by a manufacturing method thereof in a shielding material-integrated type wireless charging coil according to one embodiment. For example, a first coil 2010 and a second coil 2020 may be integrally formed with a shielding material 2040.

In addition, when a shielding material in a state of liquid or powder which is a casting material is injected through a gate disposed on an upper mold or a lower mold, an embossed burr may be generated in correspondence with the gate into which the casting material is injected. In this case, when mounting the shielding material-integrated type wireless charging coil on a wiring board or the like, a separate step for cutting the embossed burr should be added. Further, even though the separate step is added, a burr cutting portion obtained by cutting the embossed burr remains, and thus there is a limit to obtaining perfect adhesion at the time of mounting on the wiring board or the like.

When a shielding material-integrated type wireless charging coil according to one embodiment is mounted on a wiring board or the like, a gate may be formed on an upper surface or a lower surface of the upper mold or the lower mold such that the burr cutting portion is formed on an upper surface of the shielding material (i.e., the surface opposite to the mounting surface). For example, as shown in FIG. 20, a burr cutting portion 2041 may be disposed on an upper surface of the shielding material 2040. In the shielding material-integrated type wireless charging coil according to the embodiment, since the burr cutting portion may not be formed on the mounting surface, it is possible to further improve adhesion at the time of mounting on the wiring board or the like.

FIG. 21 is a view for describing a shielding material-integrated type wireless charging coil and a manufacturing method thereof according to another embodiment.

In the following description, except for overlapping descriptions of a shielding material-integrated type wireless charging coil and a manufacturing method thereof according to FIGS. 14, 16, and 18, a difference between configurations will be mainly described.

Referring to FIG. 21, one or more coils of a plurality of coils may be integrated with a shielding material by a manufacturing method thereof in a shielding material-integrated type wireless charging coil according to one embodiment. For example, a first coil 2110 and a second coil 2120 may be integrally formed with a shielding material 2140.

In addition, when a shielding material in a state of liquid or powder which is a casting material is injected through a gate disposed on an upper mold or a lower mold, an embossed burr may be generated in correspondence with the gate into which the casting material is injected. In this case, when mounting the shielding material-integrated type wireless charging coil on a wiring board or the like, a separate step for cutting the embossed burr should be added. Further, even though the separate step is added, a burr cutting portion obtained by cutting the embossed burr remains, and thus there is a limit to obtaining perfect adhesion at the time of mounting on the wiring board or the like.

When a shielding material-integrated type wireless charging coil according to another embodiment is mounted on a wiring board or the like, a gate may be formed on an outer wall of the upper mold or the lower mold such that the burr cutting portion is formed on an outer wall portion of the shielding material (i.e., the surface perpendicular to the mounting surface). For example, referring to FIG. 21, the shielding material-integrated type wireless charging coil may include a shielding material 2140 including first to fourth outer wall portions 2140a to 2140b. The first outer wall portion 2140a and the third outer wall portion 2140c of the shielding material may be disposed to correspond to both the first coil 2110 and the second coil 2120. The second outer wall portion 2140b of the shielding material may be disposed to correspond to the first coil 2110 only. The burr cutting portion 2141 may be disposed on the first outer wall portion 2140a or the third outer wall portion 2140c. In the shielding material-integrated type wireless charging coil according to another embodiment, since the burr cutting portion may not be formed on the mounting surface, it is possible to further improve adhesion at the time of mounting on the wiring board or the like.

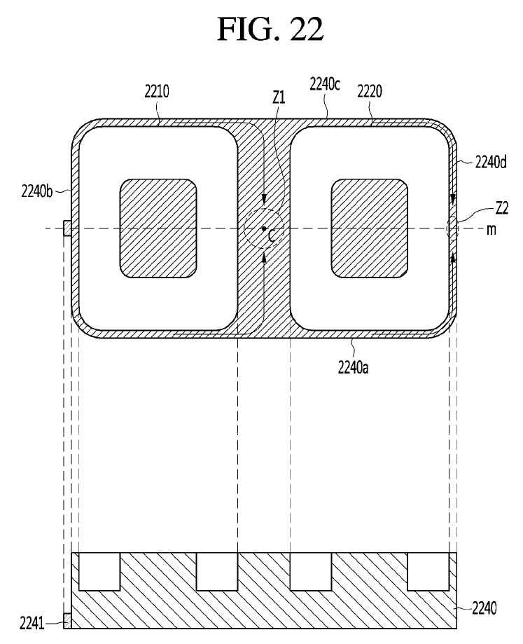

FIG. 22 is a view for describing a shielding material-integrated type wireless charging coil and a manufacturing method thereof according to another embodiment.

In the following description, except for overlapping descriptions of a shielding material-integrated type wireless charging coil and a manufacturing method thereof according to FIGS. 14, 16, and 18, a difference between configurations will be mainly described.

Referring to FIG. 22, one or more coils of a plurality of coils may be integrated with a shielding material by a manufacturing method thereof in a shielding material-integrated type wireless charging coil according to one embodiment. For example, a first coil 2210 and a second coil 2220 may be integrally formed with a shielding material 2240.

In a shielding material-integrated type wireless charging coil according to still another embodiment, coupling portions Z1 and Z2 may be formed in a shielding material by forming a gate on an outer wall portion of an upper mold or a lower mold and flowing a shielding material in a state of liquid or powder which is a casting material from a side of the upper mold or the lower mold. The coupling portion refers to a portion in which the strength may be lowered due to factors such as fluidity, viscosity change, injected time difference and the like when injecting the shielding material in a liquid or powder state. Therefore, there is a problem that cracks tend to occur depending on an environment in which the coupling portion is formed, and thus a manufacturing method considering the formation of the coupling portion is required. In order to have the best strength in consideration of the coupling portion, the shielding material injected through the gate should be configured so as to match a length of a rejoined path (the path is symmetrical) after being divided into a plurality of coils, an upper mold or a bottom mold, and it is necessary to meet with maintaining uniform curing time and viscosity.

In the shielding material-integrated type wireless charging coil according to still another embodiment, when a gate is formed on an outer wall portion of an upper mold or a lower mold, the gate may be formed to be disposed toward the normal direction on an extension line of a normal line m at one point c of a cross section of the coil. A burr cutting portion obtained by cutting a burr formed in correspondence with the gate may be formed toward the normal direction on an extension line of the normal line m at one point c of a cross section of the coil. For example, referring to FIG. 22, the shielding material-integrated type wireless charging coil may include a shielding material 2240 including first to fourth outer wall portions 2240a to 2240b. The first outer wall portion 2240a and the third outer wall portion 2240c of the shielding material may be disposed to correspond to both the first coil 2210 and the second coil 2220. The second outer wall portion 2240b of the shielding material may be disposed to correspond to the first coil 2210 only. The fourth outer wall portion 2240d of the shielding material may be disposed to correspond to the second coil 2210 only. A burr cutting portion 2241 may be disposed on the second outer wall portion 2140b or the fourth outer wall portion 2140d toward the normal direction on an extension of the normal line m at one point c of a cross section of the coil.

According to this configuration, the shielding material in a state of liquid or powder flows toward the normal direction (m) of the coil, and is divided through a portion corresponding to the coil of the mold. The divided shielding material moves to the opposite side of the gate while surrounding the coil, and is mixed with each other. Therefore, the time until the shielding materials are mixed together may be made maximally constant, and since curing progresses in a state in which they are evenly balanced with each other, the strength of the coupling portions Z1 and Z2 may be increased. Accordingly, a shielding material with a higher strength may be molded.

In particular, even though stress of the shielding material is generated by heat generated in the coil during wireless charging, strength may be secured sufficiently in the coupling portion and cracks may be prevented, and thus a shielding material with higher strength may be molded.

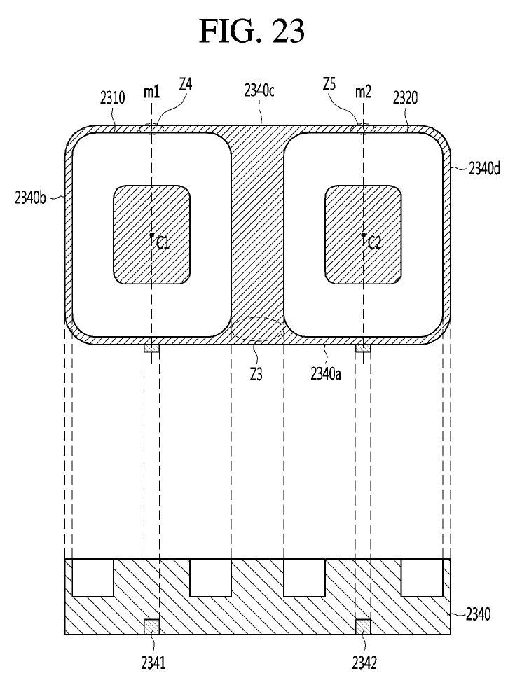

FIG. 23 is a view for describing a shielding material-integrated type wireless charging coil and a manufacturing method thereof according to another embodiment.

In the following description, except for overlapping descriptions of a shielding material-integrated type wireless charging coil and a manufacturing method thereof according to FIGS. 14, 16, and 18, a difference between configurations will be mainly described.

Referring to FIG. 23, one or more coils of a plurality of coils may be integrated with a shielding material by a manufacturing method thereof in a shielding material-integrated type wireless charging coil according to one embodiment. For example, a first coil 2310 and a second coil 2320 may be integrally formed with a shielding material 2340.

In a shielding material-integrated type wireless charging coil according to still another embodiment, coupling portions Z3, Z4, and Z5 may be formed in a shielding material by forming a gate on an outer wall portion of an upper mold or a lower mold and flowing a shielding material in a state of liquid or powder which is a casting material from a side of the upper mold or the lower mold. The coupling portion refers to a portion in which the strength may be lowered due to factors such as fluidity, viscosity change, injected time difference and the like when injecting the shielding material in a liquid or powder state. Therefore, there is a problem that cracks tend to occur depending on an environment in which the coupling portion is formed, and thus a manufacturing method considering the formation of the coupling portion is required. In order to have the best strength in consideration of the coupling portion, the shielding material injected through the gate should be configured so as to match a length of a rejoined path (the path is symmetrical) after being divided into a plurality of coils, an upper mold or a bottom mold, and it is necessary to meet with maintaining uniform curing time and viscosity.

In the shielding material-integrated type wireless charging coil according to still another embodiment, when a gate is formed on an outer wall portion of an upper mold or a lower mold, the gate may be formed to be disposed toward the direction of each normal line on an extension line of each of a normal line m1 and m2 at one point c1 and c2 of a cross section of each coil. A burr cutting portion obtained by cutting a burr formed in correspondence with the gate may be formed toward the direction of each normal line on an extension line of each of the normal line m1 and m2 at one point c1 and c2 of the cross section of each coil. For example, referring to FIG. 23, the shielding material-integrated type wireless charging coil may include a shielding material 2340 including first to fourth outer wall portions 2340a to 2340b. The first outer wall portion 2340a and the third outer wall portion 2340c of the shielding material may be disposed to correspond to both the first coil 2310 and the second coil 2320. The second outer wall portion 2340b of the shielding material may be disposed to correspond to the first coil 2310 only. The fourth outer wall portion 2340d of the shielding material may be disposed to correspond to the second coil 2310 only. A first burr cutting portion 2341 may be disposed on the first outer wall portion 2140a or the third outer wall portion 2140c toward the normal direction on an extension of the normal line m1 at one point c1 of a cross section of the first coil 2310. A second burr cutting portion 2342 may be disposed on the first outer wall portion 2140a or the third outer wall portion 2140c toward the normal direction on an extension of the normal line m2 at one point c2 of a cross section of the second coil 2320.

According to this configuration, the shielding material in a state of liquid or powder flows toward the direction of normal line m1 and m2 of each coil, and is divided through a portion corresponding to each coil of the mold. The divided shielding material moves to the opposite side of the gate while surrounding each coil, and is mixed with each other. Therefore, the time until the shielding materials are mixed together may be made maximally constant, and since curing progresses in a state in which they are evenly balanced with each other, the strength of the coupling portions Z3, Z4, and Z5 may be increased. Accordingly, a shielding material with a higher strength may be molded.

In particular, even though stress of the shielding material is generated by heat generated in the coil during wireless charging, strength may be secured sufficiently in the coupling portion and cracks may be prevented, and thus a shielding material with higher strength may be molded.

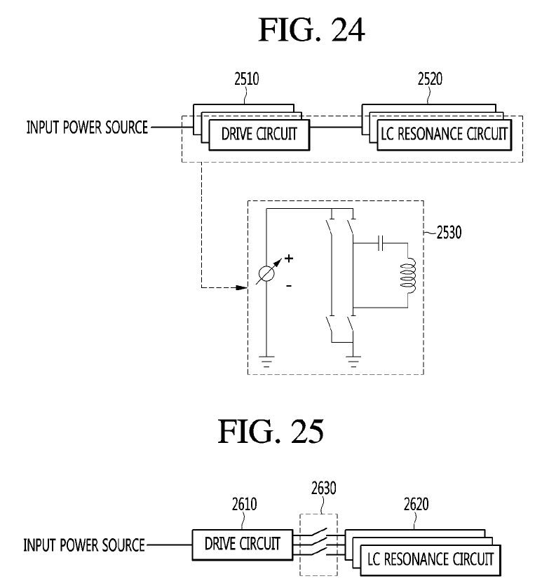

FIG. 24 is a view for describing three drive circuits including a full-bridge inverter in a wireless power transmitter including a plurality of coils according to one embodiment.

Referring to FIG. 24, when each of three coils included in a wireless power transmitter has a different inductance, three drive circuits 2510 connected to respective coils and three LC resonance circuits 2520 each including a capacitor for generating the same resonance frequency are required.

Even though the wireless power transmitter includes a plurality of coils, the resonant frequency generated by the wireless power transmitter to perform power transmission should not be different depending on each of the transmission coils, and must follow the standard resonant frequency that the wireless power transmitter supports.

The resonance frequency generated in the LC resonance circuit 2520 may be different depending on the inductance of the coil and the capacitance of the capacitor.

For example, the resonant frequency (fr) may be 100 KHz, and when the capacitance of the capacitor connected to the coil to generate the resonance frequency is 200 nF, all three coils should satisfy 12.5 uH in order to use only one capacitor. When the inductances of the three coils are different from each other, three capacitors having different capacitances corresponding to each other are required in order to generate a resonance frequency of 100 kHz. Accordingly, in addition, three drive circuits 2510 including an inverter for applying an AC voltage are also required in each of the LC resonance circuits 2520.

FIG. 25 is a view for describing a wireless power transmitter including a plurality of coils and one drive circuit according to one embodiment.

Referring to FIG. 25, when inductances of three coils of a wireless power transmitter are equal, the wireless power transmitter may include only one drive circuit 2610, and it is possible to control a switch 2630 so as to connect the coil of the wireless power receiver and the coil of the wireless power transmitter having the highest power transmission efficiency among the one drive circuit 2610 and the three coils.

Compared with FIG. 24, in the wireless power transmitter, an area occupied by components may be reduced by using only one drive circuit 2610, and thus it is possible to miniaturize the wireless power transmitter itself and to reduce costs of raw materials required for manufacturing.

In one embodiment, a wireless power transmitter may use a signal strength indicator in a ping phase to calculate power transfer efficiency between three coils of the wireless power transmitter and a coil of a wireless power receiver.

Alternatively, in another embodiment, a wireless power transmitter may select a coil of the wireless power transmitter having a high coupling coefficient by calculating a coupling coefficient between transmission and reception coils.

Alternatively, in another embodiment, a wireless power transmitter may control the switch 2630 to connect with the drive circuit 2610 by calculating a Q factor to identify the coil of the wireless power transmitter with high Q factor.

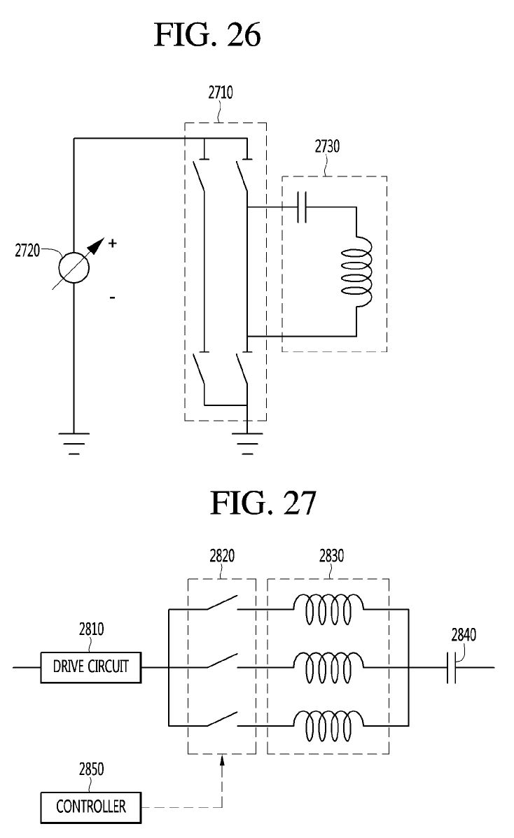

FIG. 26 is a view for describing a drive circuit including a full-bridge inverter according to one embodiment.

Referring to FIG. 26, a power transmitter included in a wireless power transmitter may generate a specific operation frequency for power transmission. The power transmitter may include an inverter 2710, an input power source 2720, and an LC resonance circuit 2730.

The inverter 2710 may convert a voltage signal from the input power source, and transmit it to the LC resonance circuit 2730. In one embodiment, the inverter 2710 may be a full-bridge inverter or a half-bridge inverter.

The power transmitter may use a full-bridge inverter for a higher output than the output by the half-bridge inverter. The full-bridge inverter may output a voltage two times higher than that of the half-bridge inverter, and may apply it to the LC resonance circuit 1280 by using four switches in the form of adding two switches to the half-bridge inverter.

FIG. 27 is a view for describing a plurality of switches for connecting any one of a plurality of coils of a wireless power transmitter to a drive circuit according to one embodiment.

Referring to FIG. 27, a power transmitter may include a drive circuit 2810 converting an input voltage, a switch 2820 connecting the drive circuit 2810 and an LC resonance circuit, a plurality of transmission coils 2830, one capacitor 2840 connected in series with a plurality coils of a wireless power transmitter, and a controller 2850 controlling the opening and closing of the switch 2820.

The controller 2850 may identify a coil of a wireless power receiver and the coil of the wireless power transmitter having the highest power transmission efficiency among the plurality of coils 2830 of the wireless power transmitter, and may control to close the switch to connect the identified coil of the wireless power transmitter with the drive circuit 2810. Methods according to the above-described embodiments may be implemented as a program to be executed by a computer and stored in a computer readable recording medium. Examples of the computer readable recording medium include a ROM, a RAM, a CD-ROM, a magnetic tape, a floppy disk, an optical data storage device, and the like, and also include what is realized in the form of carrier wave (for example, transmission through the Internet).

The computer readable recording medium may be distributed in computer systems connected via a network and the computer readable code may be stored and executed in a distributed manner. In addition, functional programs, codes and code segments for implementing the above-described method may be easily construed by programmers skilled in the art to which the embodiment pertains.

It will be understood by those skilled in the art that other changes may be made therein without departing the spirit and features of the present invention.

Therefore, the foregoing detailed descriptions are not restrictively construed in all aspects but have to be considered as illustrative purposes. The scope of the embodiment has to be determined by rational interpretation of appended claims, and all changes within the equivalent scope of the embodiment belong to the scope embodiment.

1.-10. (canceled)

11. A shielding material-integrated type wireless charging coil, the coil comprising:
a plurality of coils for transmitting or receiving wireless power; and
a shielding material integrated with at least one of the plurality of coils,
wherein the plurality of coils includes a first coil, a second coil, and a third coil,
wherein the first coil and the second coil are disposed on one surface of the shielding material, and
wherein the third coil is disposed to be overlapped on one surface of the shielding material, the first coil, and the second coil.

12. The coil of claim 11, wherein the first coil and the second coil are integrated with the shielding material.

13. The coil of claim 12, wherein the shielding material is disposed in contact with inside and outside of the first coil, and in contact with inside and outside of the second coil.

14. The coil of claim 13, wherein a burr cutting portion is disposed on an upper surface of the shielding material.

15. The coil of claim 13, wherein a burr cutting portion is disposed on an outer wall portion of the shielding material.

16. The coil of claim 15, wherein the burr cutting portion is disposed toward the normal direction on an extension line of a normal line at one point of a cross section of the plurality of coils.

17. The coil of claim 11, wherein the shielding material is disposed in contact with inside and outside of the first coil, in contact with inside and outside of the second coil, and in contact with an inside of the third coil.

18. The coil of claim 17, wherein a burr cutting portion is disposed on an upper surface of the shielding material.

19. The coil of claim 17, wherein a burr cutting portion is disposed on an outer wall portion of the shielding material.

20. The coil of claim 19, wherein the burr cutting portion is disposed toward the normal direction on an extension line of a normal line at one point of a cross section of the plurality of coils.

21. The coil of claim 11, wherein the first coil to the third coil are integrated with the shielding material.

22. The coil of claim 21, wherein the shielding material is disposed in contact with inside and outside of the first coil, in contact with inside and outside of the second coil, and in contact with inside and outside of the third coil.

23. The coil of claim 22, wherein a burr cutting portion is disposed on an upper surface of the shielding material.

24. The coil of claim 22, wherein a burr cutting portion is disposed on an outer wall portion of the shielding material.

25. The coil of claim 24, wherein the burr cutting portion is disposed toward the normal direction on an extension line of a normal line at one point of a cross section of the plurality of coils.

26. A method of manufacturing a shielding material-integrated type wireless charging coil including a first coil, a second coil, and a third coil for transmitting or receiving wireless power, and a shielding material, the method comprising:
disposing the first coil and the second coil on a bottom surface of a lower mold;
forming a cavity including at least one gate by disposing an upper mold on the lower mold;
filling the cavity with a liquid-state shielding material into the at least one gate;
curing the liquid-state shielding material; and
removing the lower mold and the upper mold.

27. The method of claim 26, further comprising disposing the third coil to be overlapped on upper surfaces of the shielding material, the first coil, and the second coil after removing the lower mold and the upper mold.

28. The method of claim 26, wherein the lower mold includes a groove disposed between an outside of the first coil and an outside of the second coil on the bottom surface.

29. The method of claim 26, wherein an embossed burr formed in accordance with the gate is cut to form a burr cutting portion on the shielding material.

30. The method of claim 26, wherein the gate is formed toward the normal direction on an extension line of a normal line at one point of a cross section of the first coil to the third coil.
